(19) United States
(12) Patent Application Publication
(10) Pub. No.: US 2026/0360700 A1
(43) Pub. Date: Nov. 12, 2026

(54) BATTERY CELL, BATTERY APPARATUS, POWER CONSUMING APPARATUS, AND ENERGY STORAGE APPARATUS

(71) Applicant: CONTEMPORARY AMPEREX TECHNOLOGY CO., LIMITED, Ningde (CN)

(72) Inventors: Xinde Ye, Ningde (CN); Xiaofeng Zhang, Ningde (CN); Xiaoyang Jia, Ningde (CN); Jia Li, Ningde (FJ); Tianyue Yuan, Ningde (CN); Song Li, Ningde (CN)

(21) Appl. No.: 19/464,641

(22) Filed: Jan. 30, 2026

Related U.S. Application Data
(63) Continuation of application No. PCT/CN2025/094409, filed on May 12, 2025.

(51) Int. Cl. H01M 4/136; H01M 4/02; H01M 4/58; H01M 4/62; H01M 10/0585; H01M 10/42; H01M 50/105; H01M 50/119; H01M 50/133; H01M 50/186; H01M 50/426; H01M 50/451; H01M 50/457; H01M 50/46

(52) U.S. Cl. CPC H01M 4/136; H01M 4/5825; H01M 4/623; H01M 4/625; H01M 10/0585; H01M 10/4235; H01M 50/105; H01M 50/119; H01M 50/133; H01M 50/186; H01M 50/426; H01M 50/451; H01M 50/457; H01M 50/461; H01M 2004/021; H01M 2004/028

(57) ABSTRACT

A battery cell, a battery apparatus, a power consuming apparatus, and an energy storage apparatus are disclosed. The battery cell includes a stacked electrode assembly with a positive electrode plate and a negative electrode plate. The positive electrode plate has a current collector and a film layer comprising lithium-containing transition metal phosphate particles, at least partly coated with carbon. In a cumulative distribution curve of graphitization degree C values obtained from the positive electrode film layer using a laser confocal Raman spectrometer in area mapping mode, the median C₅₀ of the graphitization degree ranges from 0.95 to 1.20. The graphitization degree C value is defined as I_G/I_D, where I_G represents the intensity of the G band at 1580±100 cm⁻¹ and I_D represents the intensity of the D band at 1350±100 cm⁻¹. When fully discharged, the positive electrode plate has a compaction density of 2.3-2.6 g/cm³.

### CROSS-REFERENCE TO RELATED APPLICATIONS

The present application is a continuation of International Application PCT/CN2025/094409, filed on May 12, 2025, the entire contents of which are incorporated herein by reference.

### TECHNICAL FIELD

The present application relates to the technical field of secondary battery cells, and in particular, to a battery cell, a battery apparatus, a power consuming apparatus, and an energy storage apparatus.

### BACKGROUND

In recent years, lithium-ion secondary battery cells have been widely used in energy storage power supply systems such as water power stations, thermal power stations, wind power stations, and solar power stations, and in a plurality of fields such as electric tools, electric bicycles, electric motorcycles, electric vehicles, military equipment, and aerospace.

With pursuit of the market for a range and a service life of batteries, higher requirements are put forward for a battery capacity and cycle performance. However, existing technologies struggle to achieve simultaneous improvement in these performance aspects, and how to achieve a balance between the battery capacity and the cycle performance becomes a technical problem that needs to be urgently resolved in the art.

### SUMMARY

The present application is made in view of the foregoing problems, and an objective of the present application is to provide a battery cell with both a high capacity and good cycle performance.

According to a first aspect of the present application, a battery cell is provided. The battery cell includes a stacked electrode assembly. The stacked electrode assembly includes a positive electrode plate and a negative electrode plate. The positive electrode plate includes a positive electrode current collector and a positive electrode film layer disposed on at least one side of the positive electrode current collector. The positive electrode film layer includes lithium-containing transition metal phosphate particles with at least a portion of a surface provided with a carbon material. In a cumulative distribution curve of a graphitization degree C value obtained from the positive electrode film layer in an area mapping mode of a laser microscopic confocal Raman spectrometer, a median C₅₀ of the graphitization degree ranges from 0.95 to 1.20. The graphitization degree C value is I_{G}/I_{D}. I_{G} represents the intensity of the G band at 1580±100 cm⁻¹ in Raman spectra, and IP represents the intensity of the D band at 1350±100 cm⁻¹ in Raman spectra. When the battery cell is in a fully-discharged state, a compaction density of the positive electrode plate ranges from 2.3 g/cm³ to 2.6 g/cm³.

In the present application, a structure of the stacked electrode assembly and a manner of improving the compaction density of the positive electrode plate are used, to reduce invalid space inside the battery cell, and improve space utilization, so that a volume energy density and a capacity of the battery cell are improved. In addition, the median C₅₀ (which reflects an order degree of a carbon coating material) of the graphitization degree is adjusted, to reduce frictional resistance between the particles, enhance a slip capability of the particles in the positive electrode film layer, mitigate stress concentration in the positive electrode film layer, and reduce a risk of falling off of the film layer in a cycle process, thereby finally achieving an effective balance between a high capacity and good cycle performance of a battery.

In any embodiment, in the cumulative distribution curve of the graphitization degree C value obtained from the positive electrode film layer in the area mapping mode of the laser microscopic confocal Raman spectrometer, the median C₅₀ of the graphitization degree ranges from 1.01 to 1.13.

The graphitization degree of the positive electrode film layer is within the foregoing range, to help further improve the slip capability of the particles in the positive electrode film layer, mitigate the stress concentration in the positive electrode film layer, and reduce the risk of falling off of the film layer in the cycle process, so that a cycle life of the battery cell is further improved.

In any embodiment, based on a total area of particles in a cross section of the positive electrode film layer in a thickness direction of the electrode plate, an area percentage of particles whose particle size R1 meets R1≥1000 nm ranges from 12% to 50%, and optionally, ranges from 12% to 40%.

The area percentage of the particles whose particle size R1 meets R1≥1000 nm in the cross section of the positive electrode film layer in the thickness direction of the electrode plate is within the range from 12% to 50%, and further, within the range from 12% to 40%, so that not only the compaction density of the electrode plate can be improved, but also a probability of falling off of the film layer is not increased. Therefore, a problem of capacity diving is relieved when the energy density of the battery cell is improved, and a cycle life of the battery is considered.

In any embodiment, in the cross section of the positive electrode film layer in the thickness direction of the electrode plate, in an area-weighted cumulative distribution curve of sphericity of particles whose particle size R1 meets R1≥1000 nm, a median L_{R1A1}50 of sphericity ranges from 0.6 to 0.8, optionally, ranges from 0.65 to 0.75, and further optionally, ranges from 0.67 to 0.75.

In the cross section of the positive electrode film layer in the thickness direction of the positive electrode plate, in the area-weighted cumulative distribution curve of the sphericity of the particles whose particle size R1 meets R1≥1000 nm, L_{R1A50} is within the range from 0.65 to 0.75, and further, within the range from 0.67 to 0.75, to help further mitigate stress concentration at large particles in the positive electrode film layer of the stacked electrode assembly, thereby reducing the probability of falling off of the film layer, and improving the cycle life of the battery.

In any embodiment, in a cumulative distribution curve of a coating value B obtained from the positive electrode film layer in the area mapping mode of the laser microscopic confocal Raman spectrometer, a median B₅₀ of the coating value B ranges from 0.30 to 0.60. The coating value B is I_{P}/I_{D}. I_{P} represents the intensity of the P band at 948±100 cm⁻¹ in Raman spectra, and I_{P} represents the intensity of the D band at 1350±100 cm⁻¹ in Raman spectra.

When the median B₅₀ of the coating value of the positive electrode film layer is within the foregoing range, it indicates that a carbon coating material of a positive electrode active material is dense and uniform, to help improve slip uniformity of the positive electrode film layer during rolling, and mitigate a phenomenon of stress concentration of the positive electrode film layer. In addition, through the dense and uniform carbon coating material, the large particles in the positive electrode film layer are more easily slipped during compaction, to mitigate a phenomenon of stress concentration at the large particles in the positive electrode film layer, reduce the probability of falling off of the film layer, improve the problem of capacity diving of the battery, and improve the cycle life of the battery.

In any embodiment, the lithium-containing transition metal phosphate particles include a component shown in the following general formula:

LiₘFeₓP_{y}OⱼQ_{q} Formula I, where
Q includes one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

In any embodiment, the lithium-containing transition metal phosphate particles in the positive electrode film layer include one or more of lithium iron phosphate, lithium manganese phosphate, lithium vanadium fluorophosphate, lithium manganese iron phosphate, and modified materials thereof.

In any embodiment, the lithium-containing transition metal phosphate particles in the positive electrode film layer include one or more of lithium iron phosphate and a doped modified material thereof, and a coating modified material.

In any embodiment, an iron dissolution rate of the positive electrode active material ranges from 658 ppm to 1921 ppm, and optionally, ranges from 658 ppm to 1485 ppm.

In any embodiment, based on a total mass of the lithium-containing transition metal phosphate particles, a mass content of titanium ranges from 500 ppm to 8000 ppm, and optionally, ranges from 1000 ppm to 3000 ppm.

In this embodiment of the present application, the titanium with a large content is added to the lithium-containing transition metal phosphate particles, so that reactivity of a synthesis raw material of the positive electrode active material is reduced, thereby controlling a proportion of the large particles when the positive electrode active material has a high graphitization degree, mitigating the stress concentration in the positive electrode film layer, reducing the probability of falling off of the film layer, and achieving a balance between improving an energy density of the battery and the cycle life of the battery.

In any embodiment, based on the total mass of the lithium-containing transition metal phosphate particles in the positive electrode film layer, a mass content of vanadium ranges from 500 ppm to 5000 ppm, and optionally, ranges from 500 ppm to 3000 ppm.

The vanadium in the positive electrode film layer may be in a plurality of valence states. Vanadium of the +5 state (V⁵⁺) may be doped at a site of phosphorus. Due to a large radius of the vanadium of the +5 state, lattice distortion may be caused, and a diffusion channel of lithium ions is expanded, thereby improving ionic conductivity of the positive electrode active material and improving kinetic performance of the battery. Vanadium of the +3 state (V³⁺) may be doped at a site of transition metal, and a lithium vacancy is generated through charge compensation, thereby improving electron conductivity of the positive electrode active material. In addition, distribution uniformity of the vanadium in the lithium-containing transition metal phosphate particles is improved, to help further improve kinetic performance and reaction uniformity of the positive electrode film layer, thereby further improving kinetic performance and cycle performance of the battery cell.

In any embodiment, a porosity of the positive electrode film layer ranges from 14% to 28%.

The porosity of the positive electrode film layer is within the foregoing range, so that the positive electrode film layer has an electrolyte solution infiltration rate and tortuosity that are good, to help diffusion of a liquid phase and a solid phase of lithium ions, help reduce concentration polarization of a thick electrode plate, and improve the kinetic performance of the battery. In addition, this helps relieve volume expansion of the positive electrode plate in the cycle process, and reduce mechanical stress of the film layer and mitigate the phenomenon of stress concentration, thereby reducing the risk of falling off of the film layer.

In any embodiment, a resistivity of the positive electrode film layer ranges from 10 Ω·cm to 35 Ω·cm.

The resistivity of the positive electrode film layer is within the foregoing range, to help reduce electron transport impedance, reduce charge and discharge polarization, and improve rate performance and the cycle performance of the battery.

In any embodiment, a single-side thickness of the positive electrode film layer is denoted as H, and H ranges from 70 μm to 120 μm.

In any embodiment, the single-side thickness of the positive electrode film layer is denoted as H, and H ranges from 90 μm to 120 μm.

The single-side thickness of the positive electrode film layer is within the foregoing range, to help improve a load of the positive electrode active material in the battery, improve a capacity of the battery, and reduce the risk of falling off of the film layer in the cycle process.

In any embodiment, the single-side thickness of the positive electrode film layer is denoted as H, and H ranges from 100 μm to 120 μm.

The thickness of the positive electrode film layer is increased to help improve the load of the positive electrode active material and help improve the capacity of the battery. However, it is discovered by an applicant of the present application that, when the single-side thickness of the positive electrode film layer is greater than or equal to 100 μm, in the cycle process of the battery, volume expansion of the positive electrode film layer is more obvious, and consequently, more stress is generated, the phenomenon of stress concentration of the positive electrode film layer is more obvious, and the risk of falling off of the film layer is increased. As a result, the cycle performance of the battery is affected. In this embodiment of the present application, the capacity of the battery is increased by increasing the thickness of the positive electrode film layer, and the median C₅₀ of the graphitization degree in the cumulative distribution curve of the graphitization degree C value obtained from the positive electrode film layer in the area mapping mode of the laser microscopic confocal Raman spectrometer is simultaneously controlled, to improve the slip capability of the particles in the positive electrode film layer, thereby helping mitigate the phenomenon of stress concentration of the film layer and reduce the risk of falling off of the film layer, and further improving the cycle life of the battery.

In any embodiment, a base coating layer is disposed in a bottom region of the positive electrode film layer close to the positive electrode current collector. The base coating layer includes a conductive agent and a binder. The conductive agent includes carbon nanotubes and conductive carbon black. The binder includes a vinylidene fluoride polymer.

In any embodiment, a thickness of the base coating layer ranges from 0.5 μm to 5 μm.

The base coating layer provided in this embodiment of the present application helps improve a bonding force between the positive electrode film layer and the positive electrode current collector, and mitigate the phenomenon of stress concentration at the large particles, thereby reducing the probability of falling off of the positive electrode film layer and improving cycle stability of the battery. In addition, in comparison with that the positive electrode current collector is in direct contact with the positive electrode film layer, a contact area between the base coating layer and the positive electrode film layer is increased, to help increase an area for electron transport between the current collector and the positive electrode film layer, thereby reducing internal resistance of the electrode plate and improving the kinetic performance of the battery.

In any embodiment, the positive electrode film layer further includes a dispersant, and the dispersant includes hydrogenated nitrile butadiene rubber (HNBR).

After the HNBR is attached to surfaces of particles in a slurry, long-chain molecules of the HNBR form a physical barrier around the particles, to prevent the particles from approaching each other and aggregating, so that the particles maintain in an independent dispersed state in a system. In addition, the HNBR can reduce surface tension between a dispersing medium and the dispersed particles, so that the particles are more easily wetted by the medium, thereby promoting dispersion of the particles in the medium. In addition, the HNBR can further reduce interfacial energy between the particles, and reduce an aggregation phenomenon of the particles that is driven by the interfacial energy. Further, when the slurry is dried into a film, an elastic network structure of the HNBR can buffer shrinking stress generated due to volatilization of a solvent, reduce re-aggregation of the conductive agent due to a capillary force in this process, reduce an area percentage of an aggregation region of the conductive agent, and improve the kinetic performance and the cycle life of the battery.

In any embodiment, based on a mass of the positive electrode film layer, a mass content of the dispersant ranges from 0.5% to 2%.

The mass content of the dispersant is within the foregoing range, so that the particles in the positive electrode film layer can be uniformly dispersed when a high load of the positive electrode film layer is maintained, the stress concentration of the positive electrode film layer is mitigated, the problem of capacity diving of the battery is effectively relieved, and the cycle performance of the battery is improved.

In any embodiment, the positive electrode film layer further includes a conductive agent. Based on a total area of the cross section of the positive electrode film layer in the thickness direction of the electrode plate, an area percentage of agglomeration regions of the conductive agent ranges from 0.5% to 2.5%, and optionally, ranges from 1.5% to 2.5%.

When the area percentage of the agglomeration regions of the conductive agent is within the foregoing range based on the total area of the cross section of the positive electrode film layer in the thickness direction of the electrode plate, it indicates that the conductive agent is uniformly dispersed in the positive electrode film layer, and an uniform conductive network is easily formed, to particularly help reduce a problem that kinetics of the film layer is decreased because an ion transmission path is extended, reduce problems of local polarization and even lithium plating caused in the cycle process of the battery, and improve the cycle life of the battery.

In any embodiment, the conductive agent includes carbon nanotubes, and the carbon nanotubes include one or more of single-walled carbon nanotubes, few-walled carbon nanotubes, and multi-walled carbon nanotubes.

Because the carbon nanotubes have a one-dimensional structure, the carbon nanotubes can form a network structure in the positive electrode film layer. On one hand, a high-elasticity modulus of the carbon nanotubes enables the network structure of the carbon nanotubes to not only serve as a bridge for stress propagation, but also have a binding effect on the positive electrode film layer, to suppress bounce of the lithium-containing transition metal phosphate particles, effectively mitigate the stress concentration, and reduce the risk of falling off of the film layer, thereby improving the problem of capacity diving of the battery. On the other hand, excellent electrical conductivity of the carbon nanotubes enables the network structure of the carbon nanotubes to serve as an efficient electron transport channel. Even though the film layer partially falls off, the thick electrode plate can still maintain high electron transport efficiency in an intra-plane direction and the thickness direction, thereby deferring the problem of capacity diving, and further improving the kinetic performance and the cycle life of the battery.

In any embodiment, the conductive agent further includes conductive carbon black.

The conductive carbon black has a large specific surface area, and therefore has a good liquid retention capability. An expansion force of the thick electrode plate in the cycle process is large, so that an electrolyte solution is easily squeezed out. Distribution of the conductive carbon black in the positive electrode film layer helps improve a liquid retention capability of the thick electrode plate, to further relieve a phenomenon of capacity diving of the battery in the cycle process, and improve the cycle life of the battery.

In any embodiment, based on the mass of the positive electrode film layer, a mass content C1 of the carbon nanotubes meets: 0<C1≤2.5%, and a mass content C2 of the conductive carbon black meets: 0<C2≤2.5%.

The mass content of the carbon nanotubes and the mass content of the conductive carbon black are within the foregoing range, so that an agglomeration phenomenon of the carbon nanotubes can be effectively relieved, and a good conductive network structure is formed, thereby effectively mitigating the stress concentration of the positive electrode film layer, and improving e a liquid retention rate of the positive electrode plate in the long cycle process, to further reduce the risk of falling off of the film layer in the electrode plate and a polarization degree, achieve a balance between improving the kinetic performance of the battery and the problem of capacity diving, and improve the cycle life of the battery.

In any embodiment, the battery cell includes a housing. At least one stacked electrode assembly is accommodated in the housing. A dimension of the housing in a length direction is L0, a dimension of the housing in a width direction is W0, and a dimension of the housing in the thickness direction is H0. 450 mm≤L0≤1300 mm, 100 mm≤W0≤150 mm, and 14 mm≤H0≤22 mm.

In any embodiment, the dimension L0 of the housing in the length direction meets: 450 mm≤L0≤650 mm.

When the dimension L0 of the housing in the length direction meets 450 mm≤ L0≤650 mm, a length of the battery cell is small, to help shorten a current diffusion path and reduce the internal resistance of the electrode plate, thereby reducing heat generation of the battery and improving the kinetic performance of the battery. In addition, the small length of the housing helps shorten a diffusion path of the electrolyte solution in an infiltration process, and improve an infiltration rate and uniformity of the electrolyte solution, to further promote deintercalation uniformity of lithium ions in the cycle process, mitigate the phenomenon of stress concentration, reduce the risk of falling off of the film layer, and improve cycle stability of the battery cell.

In any embodiment, the dimension L0 of the housing in the length direction meets: 900 mm≤L0≤1300 mm.

When the dimension L0 of the housing in the length direction meets 900 mm≤ L0≤1300 mm, a dimension of the battery cell is long, to help reduce a volume of the housing in the battery cell, and improve a load ratio of the active material. In addition, the long battery cell can reduce a quantity of batteries required in a battery module, simplify a structural design of the battery module, and reduce a quantity and complexity of structural members in the module, thereby improving space utilization of a battery pack, and further helping improve the volume energy density of the battery cell.

In any embodiment, the housing is made of a pouch-type material. The pouch-type material includes an aluminum laminate composite film, and optionally, includes one or more of aluminum, polypropylene (PP), polybutylene terephthalate (PBT), polybutylene succinate (PBS), nylon, polyethylene terephthalate (PET), and polyethylene (PE).

In any embodiment, the housing includes a first sealing zone, and the first sealing zone is disposed at at least one end of the stacked electrode assembly extending along the width direction. The first sealing zone includes a folded edge structure extending along the length direction. A sealing adhesive is disposed on the folded edge structure. The sealing adhesive is continuously disposed in the length direction and secures the folded edge structure.

In any embodiment, the housing includes at least one second sealing zone. The second sealing zone is disposed at at least one end of the stacked electrode assembly in the length direction of the housing, and the second sealing zone is disposed on a tab side of the stacked electrode assembly.

In any embodiment, an outer periphery of the stacked electrode assembly is provided with a plurality of adhesive rings surrounding along the width direction, and the adhesive rings surrounding along the width direction are disposed at intervals along the length direction.

The adhesive rings surrounding along the width direction of the electrode assembly are arranged at intervals along the length direction, to help fix positions of the electrode plates in the electrode assembly, and reduce a probability of displacement of the electrode assembly in a shaking process of the battery. This arrangement is especially applicable to a battery with a large length, and can effectively reduce a lithium plating phenomenon caused by mutual displacement of the electrode plates in the length direction, to help maintain structural stability of space inside the battery, so that normal working of the battery is not affected.

In any embodiment, at 25 °C, a capacity of the battery cell ranges from 105 Ah to 190 Ah, and optionally, ranges from 150 Ah to 190 Ah.

According to a second aspect of the present application, a battery apparatus is provided, including the battery cell in the first aspect of the present application.

According to a third aspect of the present application, a power consuming apparatus is provided. The power consuming apparatus includes the battery apparatus in the second aspect of the present application, and the battery apparatus is configured to supply electric energy.

According to a fourth aspect of the present application, an energy storage apparatus is provided. The energy storage apparatus includes the battery apparatus in the second aspect of the present application, and the battery apparatus is configured to store electric energy.

### BRIEF DESCRIPTION OF THE DRAWINGS

FIG. 1 is a schematic diagram of a separator according to an implementation of the present application;

FIG. 2 is a schematic diagram of a separator in the existing technology;

FIG. 3 is a schematic diagram of a surface morphology of a bonding layer according to an implementation of the present application;

FIG. 4 is a schematic diagram of a pouch-type stacked battery according to the present application; and

FIG. 5 is a schematic diagram of a power consuming apparatus according to an implementation of the present application.

DESCRIPTIONS OF REFERENCE NUMERALS

5 battery cell; 50 housing; 20 separator; 201 base film; 202 ceramic layer; 203 bonding layer; X length direction; Y width direction; and Z thickness direction.

### DETAILED DESCRIPTION

Hereinafter, embodiments of an electrolyte solution, a battery cell, a battery apparatus, a power consuming apparatus, and an energy storage apparatus of the present application are specifically disclosed in the detailed description with appropriate reference to the accompanying drawings. However, there may be situations where unnecessary detailed explanations are omitted. For example, there are situations where detailed explanations of well-known matters are omitted and repeated explanations of the same structure are actually provided. Thus, the following description does not become unnecessarily lengthy, which facilitates the easy comprehension of those skilled in the art. In addition, the accompanying drawings and the following explanations are provided for those skilled in the art to fully understand the present application and are not intended to limit the subject matter recorded in the claims.

The “scope” disclosed in the present application is limited in the form of a lower limit and an upper limit. The given scope is limited by selecting a lower limit and an upper limit, and the selected lower limit and upper limit define the boundary of the special scope. The range defined in this way may include or exclude end values, and may be arbitrarily combined, that is, any lower limit can be combined with any upper limit to form a range. For example, if ranges of 60-120 and 80-110 are listed for a particular parameter, it is to be understood that ranges of 60-110 and 80-120 are also expected. In addition, if the minimum range values 1 and 2 are listed, and if the maximum range values 3, 4, and 5 are listed, the following ranges can all be expected: 1-3, 1-4, 1-5, 2-3, 2-4, and 2-5. In the present application, unless otherwise specified, the numerical range “a to b” represents an abbreviated representation of any combination of real numbers between a and b, where a and b are both real numbers. For example, the numerical range “0-5” means that all real numbers between 0-5 are listed herein, and “0-5” is merely an abbreviated representation of the combination of these numbers. In addition, when a parameter is expressed as an integer≥2, it is equivalent to disclosing that the parameter is, for example, an integer of 2, 3, 4, 5, 6, 7, 8, 9, 10, 11, 12, or the like.

Unless otherwise specified, all the embodiments and optional embodiments of the present application can be combined with each other to form new technical solutions, and such technical solutions should be considered to be included in the disclosure of the present application.

Unless otherwise specified, all the technical features and optional technical features of the present application can be combined with each other to form new technical solutions, and such technical solutions should be considered to be included in the disclosure of the present application.

Unless otherwise specified, all the steps in the present application can be performed in the order described or in random order, and preferably in the order described. For example, the method includes steps (a) and (b), meaning that the method may include steps (a) and (b) performed sequentially, or may include steps (b) and (a) performed sequentially. For example, reference to “the method may further include step (c)” indicates that step (c) may be added to the method in any order, e.g., the method may include steps (a), (b) and (c), or steps (a), (c) and (b), or steps (c), (a) and (b), or the like.

In the present application, the term “a plurality of” or “a plurality of types of” indicates two or more.

Unless otherwise specified, the terms used in the present application have well known meanings as commonly understood by a person skilled in the art.

Unless otherwise stated, the values of the parameters mentioned in the present application can be measured by various test methods commonly used in the art, for example, can be measured according to the test methods given in the embodiments of the present application. Unless otherwise specified, the test temperature of the parameters is 25 °C.

In the embodiments of the present application, a battery apparatus may include one or more battery cell assemblies, configured to supply voltage and capacity. The battery cell assembly may include a plurality of pouch-type battery cells. The plurality of pouch-type battery cells are connected in series, in parallel, or in series-parallel through a bus component. For example, the battery cell assembly is usually formed by arranging the plurality of pouch-type battery cells. The battery cell assembly may be a battery module. The battery module is an independent module formed by arranging and securing the plurality of pouch-type battery cells. For example, the battery module may be formed by tying the plurality of battery cells through a strap.

The battery apparatus may be a battery pack. The battery pack includes a box body and one or more battery cell assemblies. The battery cell assembly is accommodated in the box body. The battery cell assembly may be a battery module. The battery cell assembly may be accommodated in the box body by securing the battery module in the box body. The battery cell assembly may alternatively be accommodated in the box body by directly securing the plurality of pouch-type battery cells in the box body.

In the embodiments of the present application, the box body may include a first box body and a second box body. The first box body and the second box body are snapped to form a sealed space inside the box body to accommodate the battery cell assembly. The “sealed” means “covered” or “closed”, or may be hermetic, or may be non-hermetic. The first box body may be a top cover or a bottom plate. For example, the box body may include a top cover, a frame, and a bottom plate. The top cover and the bottom plate are connected to the frame to form a sealed space inside the box body to accommodate the battery cell assembly.

In the embodiments of the present application, the box body may be used as a part of the chassis structure of a vehicle. For example, a part of the box body may serve as at least a part of the floor of a vehicle, or a part of the box body may serve as at least a part of the cross beam and longitudinal beam of a vehicle.

In the embodiments of the present application, the battery cell may be a secondary battery. The secondary battery is a battery cell that can activate an active material through charging after the battery cell is discharged, to continue to use the battery cell. The battery cell may be a lithium-ion battery. The battery cell may be flat-shaped.

A battery mentioned in embodiments of the present application may be a single physical module including one or more battery cells to provide a higher voltage and a higher capacity. For example, the battery provided in the present application may include a battery cell, a battery module, a battery pack, or the like.

The battery cell is the smallest unit constituting the battery, and can achieve functions of charging and discharging independently.

When a plurality of battery cells are provided, the plurality of battery cells are connected in series, in parallel, or in series-parallel through a bus component. In some embodiments, the battery may be a battery module. When a plurality of battery cells are provided, the plurality of battery cells are arranged and fastened to form one battery module. In some embodiments, the battery may be a battery pack. The battery pack includes a box body and a battery cell, and the battery cell or battery module is accommodated in the box body. In some embodiments, the box body may be used as a part of the chassis structure of a vehicle. For example, a part of the box body may serve as at least a part of the underbody of a vehicle, or a part of the box body may serve as at least a part of the cross beam and longitudinal beam of a vehicle.

In some embodiments, the battery may be an energy storage apparatus. The energy storage apparatus includes an energy storage container, an energy storage cabinet, and the like.

In some implementations, the battery cell may be assembled into a battery module, and the battery module may include a plurality of battery cells. A specific quantity of battery cells may be adjusted based on application and a capacity of the battery module.

In some embodiments, the battery modules may further form a battery pack, and a quantity of battery modules included in the battery pack may be adjusted based on the application and capacity of the battery pack.

The battery cell includes an electrode assembly and an electrolyte.

The electrode assembly usually includes a positive electrode plate and a negative electrode plate. The negative electrode plate is an electrode at which reactions occur to absorb or lithiate lithium ions during charging and release lithium or delithiate lithium during discharging. The positive electrode plate is an electrode at which reactions occur to release lithium ions or delithiate lithium during charging and absorb or lithiate lithium during discharging.

Lithium-containing transition metal phosphate particles used as a positive electrode active material have significant advantages in the aspect of cycle stability, but have an intrinsic gram capacity significantly lower than that of a ternary material. The applicant discovers that a compaction density of the lithium-containing transition metal phosphate particles material can be increased in combination with a stacked electrode assembly structure, to compensate for disadvantages in a capacity and an energy density of the lithium-containing transition metal phosphate particles material. However, the process optimization also brings new technical challenges: in comparison with the ternary material, the lithium-containing transition metal phosphate particles have a more stable structure, and are not easily broken under a high pressure. As a result, the lithium-containing transition metal phosphate particles usually experience a higher pressure in a process of compacting an electrode plate, to improve the compaction density. Under a condition of a high compaction density, if a slip capability of a material is insufficient, stress concentration is easily caused due to local stress concentration in a process of rolling the electrode plate. In addition, because a stacked electrode assembly does not have a corner of a wound electrode assembly, the stacked electrode assembly has an energy density higher than that of the wound electrode assembly. However, the stacked electrode assembly is not bound by the corner in comparison with the wound electrode assembly. As a result, an extrusion force inside the stacked electrode assembly against a positive film plate is weaker than that in the wound electrode assembly. Consequently, falling off of the positive film plate is more easily exacerbated. falling off of the film layer not only directly reduces active materials participating in electrochemical reaction, but also causes an “islanding” effect. To be specific, an isolated region is formed between the particles or between the particles and a conductive agent. As a result, good electrical contact cannot be formed, and further, the film layer cannot participate in a charging and discharging process. Consequently, capacity diving of the battery is caused. In addition, the fallen off active materials block an ion transmission path, increases internal resistance of the battery, causes local overheating, and even increases a risk of thermal runaway, and consequently, a cycle life and security of the battery are seriously affected.

Based on this, according to a first aspect of the present application, a battery cell is provided. The battery cell includes a stacked electrode assembly. The stacked electrode assembly includes a positive electrode plate and a negative electrode plate. The positive electrode plate includes a positive electrode current collector and a positive electrode film layer disposed on at least one side of the positive electrode current collector. The positive electrode film layer includes lithium-containing transition metal phosphate particles with at least a portion of a surface provided with a carbon material. In a cumulative distribution curve of a graphitization degree C value obtained from the positive electrode film layer in an area mapping mode of a laser microscopic confocal Raman spectrometer, a median C₅₀ of the graphitization degree ranges from 0.95 to 1.20. The graphitization degree C value is I_{G}/I_{D}. I_{G} represents the intensity of the G band at 1580±100 cm⁻¹ in Raman spectra, and I_{P} represents the intensity of the D band at 1350±100 cm⁻¹ in Raman spectra. When the battery cell is in a fully-discharged state, a compaction density of the positive electrode plate ranges from 2.3 g/cm³ to 2.6 g/cm³.

The battery cell of the present application has a high capacity while a problem of capacity diving of the battery cell is improved, and a cycle life of a battery is considered.

Without being bound to any theory, a reason may be as follows: when a stacked electrode assembly structure is used, invalid space inside the electrode assembly can be reduced, and a corner void and an inter-layer gap that are inevitable in a winding process are effectively eliminated, so that an entire structure of the electrode assembly is more compact, thereby improving space utilization, improving a volume energy density of the battery cell, and improving a battery capacity. In addition, regularity of the stacked structure further creates an advantageous condition for a process of improving a high compaction density of the electrode plate. Under a same volume, the stacked electrode assembly can accommodate more electrode plates, and in combination with the electrode plates with a high compaction density, an energy density and a capacity output of the battery are further improved. In addition, the applicant controls the median C₅₀ of the graphitization degree in the cumulative distribution curve of the graphitization degree C value obtained from the positive electrode film layer in the area mapping mode of the laser microscopic confocal Raman spectrometer, to achieve a balance between the battery capacity and cycle performance. The median C₅₀ of the graphitization degree obtained from the positive electrode film layer in the area mapping mode of the laser microscopic confocal Raman spectrometer can reflect a graphitization degree of a carbon coating material on a surface of a lithium-containing transition metal phosphate, that is, an order degree of the carbon coating material on the surface of the lithium-containing transition metal phosphate particles. A larger graphitization degree of the lithium-containing transition metal phosphate particles. indicates more ordered arrangement of carbon atoms, so that a nearly ideal graphite layered structure is formed. This structure can effectively reduce friction between the particles, to help the particles to slide relative to each other between the layers when a force is applied, and show a good slip capability, thereby helping mitigate a phenomenon of stress concentration of the film layer, reduce a risk of falling off of the film layer, and further improve the cycle life of the battery.

In the present application, the stacked electrode assembly is an electrode assembly formed by stacking the positive electrode plate, a separator, and the negative electrode plate together.

In the present application, the positive electrode film layer includes the lithium-containing transition metal phosphate particles. However, the positive electrode film layer does not refer to only a positive electrode active material layer, and other film layers that are connected to the positive electrode active material layer and that are difficult to be distinguished, such as a base coating layer and a liquid retention layer, are collectively referred to as the positive electrode film layer.

In the present application, the lithium-containing transition metal phosphate particles are phosphate materials that contains lithium and a transition metal, and may be detected in any manner known in the field. For example, the lithium-containing transition metal phosphate particles may be detected by using an X-ray diffractometer (XRD), an energy dispersive spectrometer, and an inductively coupled plasma mass spectrometer together.

In the present application, the carbon coating layer disposed on at least a portion of the surface of the lithium-containing transition metal phosphate particles may be detected in any manner known in the field. For example, the lithium-containing transition metal phosphate particles are characterized by using a transmission electron microscope and an energy dispersive spectrometer together, so that the carbon coating layer disposed on at least a portion of the surface of the lithium-containing transition metal phosphate particles can be observed.

In the present application, the fully-discharged state is a state obtained by placing a battery in a 25 °C oven environment, resting the battery for 2 h, waiting for the temperature of the battery to maintain 25 °C, discharging the battery at a 1/3 C constant current to 2.5 V, and discharging the battery at a 0.1 C constant current to 2.0 V.

The compaction density of the positive electrode plate can be tested by using a method known in the art. For example, the battery is placed in a 25 °C oven environment and is rested for 2 h. When the temperature of the battery maintains 25 °C, the battery is discharged to 2.5 V at a ⅓C constant current and is discharged to 2.0 V at a 0.1 C constant current. The battery is disassembled to obtain the positive electrode plate. The residual electrolyte solution is processed using a dimethyl carbonate solvent. The electrode plate is dried, and is cut into a disc with an area of S. It is obtained that the mass of the disc is W₁, and the thickness T₁ of the positive electrode plate is measured using a ten-thousandth micrometer. The positive electrode film layer of the foregoing weighed electrode plate is then wiped off. The mass of the current collector is weighed and denoted as W₂, and the thickness T₂ of the current collector is measured using the ten-thousandth micrometer. The compaction density PD of the positive electrode plate=(W₁−W₂)/[(T₁−T₂)×S].

In some embodiments, when the battery cell is in the fully-discharged state, the compaction density of the positive electrode plate is optionally 2.3 g/cm³, 2.31 g/cm³, 2.32 g/cm³, 2.33 g/cm³, 2.34 g/cm³, 2.35 g/cm³, 2.36 g/cm³, 2.37 g/cm³, 2.38 g/cm³, 2.39 g/cm³, 2.40 g/cm³, 2.41 g/cm³, 2.42 g/cm³, 2.43 g/cm³, 2.44 g/cm³, 2.45 g/cm³, 2.46 g/cm³, 2.47 g/cm³, 2.48 g/cm³, 2.49 g/cm³, 2.50 g/cm³, 2.55 g/cm³, 2.60 g/cm³, or a value range between any two of the foregoing.

In the present application, the cumulative distribution curve of the graphitization degree C value is a curve obtained by sorting at least 100 obtained C values in ascending order and using the graphitization degree as a horizontal axis and the cumulative number percentage as a vertical axis. C₅₀ is a corresponding C value when the cumulative number percentage on the vertical axis of the cumulative distribution curve of the graphitization degree C value is 50%. The median C₅₀ of the graphitization degree can reflect the overall graphitization degree, i.e., the slip propensity, of particles in the positive electrode film layer in comparison with point values, and can reduce the impact of outliers during testing and improve the confidence level of test results in comparison with a mean value.

The graphitization degree C value of the positive electrode film layer may be obtained in the area mapping mode of the laser microscopic confocal Raman spectrometer. For example, specifically, a laser microscopic confocal Raman spectrometer (high-precision Renishaw laser microscopic confocal Raman spectrometer) is employed, and a 532 nm excitation wavelength is used. An appropriate amount of the positive electrode film layer is subjected to area mapping on the surface of the positive electrode film layer or the cross section of the positive electrode film layer in the thickness direction of the electrode plate. The scanning area is set to 45 μm×45 μm and is divided into a 10×10 grid. Test points are located at grid vertices with a step size of 5 μm, and a total of 100 scan points are obtained. This yields C-values at distinct locations and the cumulative distribution curve of the C-value across the area-mapped region. The positive electrode film layer in the present application may be a freshly prepared positive electrode film layer, or may be a positive electrode film layer disassembled from a battery. Residual electrolyte salt particles inevitably exist on the surface of the positive electrode film layer disassembled from the battery. To improve the test accuracy, area mapping is preferably performed on the cross section of the positive electrode film layer in the thickness direction of the electrode plate, thereby characterizing the graphitization degree of the positive electrode film layer.

The graphitization degree C value of the positive electrode film layer is obtained through the intensity ratio of the G-band to D-band in Raman spectra. The G-band, positioned at 1580±100 cm⁻¹, characterizes the carbon sp²-hybridized structure. The D-band, positioned at 1350±100 cm⁻¹, represents disordered structures. The “disorder” refers to the absence of a regular arrangement among carbon atoms in the structure. In graphite crystals, carbon atoms within the same layer form covalent bonds via sp² hybridization, while interlayer interactions are governed by van der Waals forces, facilitating slip of graphitic carbon. Therefore, the C value may characterize the graphitization degree of the positive electrode film layer. It may be understood that the graphitization degree in the positive electrode film layer mainly comes from the graphitized carbon material in the positive electrode film layer, i.e., the carbon coating material of the positive electrode active material. Although the conductive agent of carbon nanotubes rich in sp²-hybridized structure exhibits relatively high I_{G}/I_{D}, due to the low addition content and small tube diameter, the addition of the conductive agent of carbon nanotubes to the positive electrode film layer exhibits outliers in the Raman area mapping test of the positive electrode film layer, and does not affect the graphitization degree in the positive electrode film layer C₅₀. Therefore, the graphitization degree of the positive electrode film layer can also be configured to characterize the graphitization degree of the positive electrode active material.

A person skilled in the art may achieve the regulation of the graphitization degree of particles of the active material through any known process. For example, the adjustment of the graphitization degree of the particles of the active material can be achieved by regulating carbon sources, sintering temperature, sintering duration, sintering pressure, and sintering atmosphere.

When the graphitization degree of carbon on the surface of the positive electrode active material is higher, the proportion of graphitic carbon in the positive electrode film layer is higher, and it is easier for particles to slip through the carbon structure with a high graphitization degree in a coating layer, thereby mitigating the phenomenon of stress concentration in the electrode plate, mitigating a phenomenon of falling off of the film layer, and improving the cycle performance of the battery.

In some embodiments, in the cumulative distribution curve of the graphitization degree C value obtained from the positive electrode film layer in the area mapping mode of the laser microscopic confocal Raman spectrometer, the median C₅₀ of the graphitization degree is optionally 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, or a value range between any two of the foregoing.

In some embodiments, in the cumulative distribution curve of the graphitization degree C value obtained from the positive electrode film layer in the area mapping mode of the laser microscopic confocal Raman spectrometer, the median C₅₀ of the graphitization degree ranges from 1.01 to 1.13.

The graphitization degree of the positive electrode film layer is further within the foregoing range, to help further improve the slip propensity of the particles in the positive electrode film layer, and mitigate the stress concentration in the positive electrode film layer, so that the long cycle stability of the battery cell is further improved.

In some embodiments, in the cumulative distribution curve of the graphitization degree C value obtained from the positive electrode film layer in the area mapping mode of the laser microscopic confocal Raman spectrometer, a concentration degree (C₉₀-C₁₀)/C₅₀ of the C value ranges from 0.01 to 0.05.

Refer to the foregoing descriptions, by analogy, C₉₀ is a corresponding C value when the cumulative number percentage on the vertical axis of the cumulative distribution curve of the graphitization degree C value is 90%, and C₁₀ is a corresponding C value when the cumulative number percentage on the vertical axis of the cumulative distribution curve of the graphitization degree C value is 10%. The concentration degree of the C value is represented by (C₉₀-C₁₀)/C₅₀. (C₉₀-C₁₀)/C₅₀ not only reflects most C values, but also reflects a width of distribution of graphitization degrees of the particles in the positive electrode film layer without being affected by an outlier. A small concentration degree of the C value of the positive electrode film layer indicates a small width of the distribution of the graphitization degrees of the particles in the positive electrode film layer and good concentration.

In some embodiments, in the cumulative distribution curve of the graphitization degree C value obtained from the positive electrode film layer in the area mapping mode of the laser microscopic confocal Raman spectrometer, the concentration degree (C₉₀-C₁₀)/C₅₀ of the C value is optionally 0.01, 0.02, 0.023, 0.025, 0.03, 0.035, 0.036, 0.039, 0.04, 0.045, 0.05, or a value range between any two of the foregoing.

When the concentration degree of the C value of the positive electrode film layer ranges from 0.01 to 0.05, it indicates that a consistency degree of the graphitization degrees of the particles in the positive electrode film layer is high, which means that the positive electrode active material has good coating uniformity and consistency, so that slip resistance caused by inconsistency of the graphitization degrees of the particles in the positive electrode active material and further caused local stress concentration can be mitigated, and a risk of falling off of the film layer is reduced, thereby improving the long cycle stability of the battery cell.

In some embodiments, in the cumulative distribution curve of the graphitization degree C value obtained from the positive electrode film layer in the area mapping mode of the laser microscopic confocal Raman spectrometer, the concentration degree (C₉₀-C₁₀)/C₅₀ of the C value ranges from 0.02 to 0.04.

The median C₅₀ of the graphitization degree of the positive electrode film layer is within the foregoing range, to help further improve the slip propensity of the particles, so that the local stress concentration is further mitigated when high kinetic performance of the battery is maintained, the risk of falling off of the film layer is reduced, and a balance between the battery performance and the energy density is achieved.

In some embodiments, based on a total area of particles in a cross section of the positive electrode film layer in a thickness direction of the electrode plate, an area percentage of particles whose particle size R1 meets R1≥1000 nm ranges from 12% to 50%.

In the present application, the term “particle” refers to an entity within the positive electrode film layer that exhibits a discernible and complete boundary in the field of view at a specified magnification (e.g., 10k×). Defects or scratches may exist within the particle, but no complete boundary sufficient to segment the particle is identifiable within the particle. The positive electrode film layer in the present application may be a freshly prepared positive electrode film layer, or may be a positive electrode film layer disassembled from a battery.

A particle identification method is specifically as follows: cutting the positive electrode film layer along a thickness direction of the electrode plate using an argon ion beam (e.g., Equipment Model: Leica EM TIC 3X CP, Operating Voltage: 6 kV, and Operating Duration: 6 h), after a cross section is exposed, observing the cross section of the positive electrode film layer in the thickness direction of the electrode plate using a scanning electron microscope (e.g., Equipment Model: Hitachi SU8230, Operating Voltage: 3 kV, Beam Current: high, Detector Model: U (LA100), and Operating Distance: <5 mm). Images are acquired using a field emission scanning electron microscope (FESEM) in secondary electron mode at a non-edge position (after an edge of the electrode plate is observed under the scanning electron microscope, the field of view is adjusted to the central portion of the sample) of the cross section of the positive electrode film layer. Electron micrographs are captured at a magnification of 10k×. Particles in the electron micrographs are analyzed using ImageJ software (version 1.46r, win64). A use method of the ImageJ software is specifically as follows: loading a scanning electron micrograph to be analyzed; identifying particles using the Cellpose plugin, followed by manual correction; and reading and collecting statistics of data using ImageJ. A specific method for particle identification using the Cellpose plugin is as follows: setting the segmentation diameter parameter (diameter in the Segmentation module) to 15 pixels, and clicking “runcyto3” to perform particle identification; and manually annotating particles in the image that are not identified by the software, incompletely identified by the software, or inaccurately identified. The particles in the image that are not identified by the software, incompletely identified by the software, or inaccurately identified primarily include the following types: 1. particles are oversized or particles have surface scratches, and as a result fail to be identified or fail to be completely identified; 2. scratches are generated on the surface of particles during argon ion beam cutting, and may be misinterpreted as particle boundaries, leading to identification errors; 3. particles are excessively undersized and fail to successfully identified; and 4. particles are located at a field-of-view edge of an electron microscope, with the interior penetrated by the edge, preventing their complete morphology from being displayed, and as a result partial particles are identified as complete particles, leading to identification errors. The particles that are not identified or inaccurately identified are manually calibrated, a specific procedure being as follows: deleting large particles that are located at the edges of the scanning electron microscope and fail to be completely displayed; determining whether fissures or scratches exist in other particles that are not identified or inaccurately identified, if no fissure or scratch exists inside a particle, determining the particle as one particle, and manually annotating the particle based on a manually observed contour of the particle; in response to a fissure or scratch existing inside a particle, determining whether the fissure or scratch penetrates the particle, and if the fissure or scratch does not penetrate the particle, determining the particle as one particle, and manually annotating the particle; in response to the fissure or scratch penetrating a particle, determining whether the fissure or scratch has a linear shape or an irregular shape; in response to the fissure or scratch having an irregular shape, determining that the fissure or scratch is a boundary between particles, and identifying the particles along the boundary; in response to the fissure or scratch having a linear shape, performing contrast comparison; in response to low contrast and the absence of fissure texture, determining the fissure or scratch as a surface scratch, and annotating the particle as one particle; and in response to high contrast and the presence of fissure texture, determining that the fissure or scratch is a boundary between particles, and identifying the particle as two particles. Following manual annotation, information unrelated to particles during automated image processing is eliminated, thereby completing the determination and annotation of particles in the image.

It may be understood that particles in the cross section of the positive electrode film layer in the thickness direction of the electrode plate, especially particles whose particle size is greater than 50 nm, mainly come from a positive electrode active material. Therefore, in the embodiments of the present application, the distribution of lithium-containing transition metal phosphate particles in the positive electrode film layer can be accurately and objectively reflected by observing and collecting statistics of the areas of the particles in the cross section of the positive electrode plate in the thickness direction of the electrode plate.

In existing technologies, the particle size distribution of the positive electrode active material is typically characterized using a laser particle size analyzer via the Malvern laser diffraction method. However, the applicant's research demonstrates that due to the tendency of lithium-containing transition metal phosphate particles to agglomerate, the Malvern laser diffraction method based on laser scattering principles predominantly measures the particle size of particle agglomerates rather than the true particle size of particles in the positive electrode active material. Furthermore, this method fails to accurately reflect the dispersion state of the positive electrode active material within the film layer, as the dispersion degree of the positive electrode active material within the film layer improves during slurry preparation and film formation/rolling. Test results obtained using the Malvern laser diffraction method are influenced by the particle size, specific surface area, and agglomeration degree of the positive electrode active material. Compared to the actual dispersion state within the electrode plate, this method underestimates the number of large particles and overestimates that of small particles. Consequently, the particle sizes measured using the Malvern laser diffraction method cannot be equated or extrapolated to those statistically derived from the embodiments of the present application.

In the cross section of the positive electrode film layer in the thickness direction of the electrode plate, a test method for the area percentage of the particles whose particle size R1 meets R1≥1000 nm is specifically as follows: identifying the particles in the positive electrode film layer using the foregoing method in the present application, importing an image with particle determination and identification completed into the ImageJ software for analysis, completing the scale bar setup based on the scanning electron micrograph, and statistically analyzing the particle sizes, areas, sphericity, and roughness of the particles in the cross section of the positive electrode film layer in the thickness direction of the electrode plate using “Feret diameter”, “Area”, “Round”, and “Solidity” analysis functions. According to the software manual (ImageJ User Guide IJ 1.46r), the analyzed “Feret” parameter represents the maximum distance between any two parallel lines in the two-dimensional projection of a particle, thereby characterizing the particle size of the particle. The obtained “Area” parameter represents the pixel area of the particle. The particles whose particle size is less than 50 nm are prone to a large error in statistics and are very difficult to accurately identify, and the particle size of the conductive agent is usually less than 50 nm and causes a large error to a statistical result. Therefore, in the process of collecting statistics of particle sizes in the present application, the particles whose particle size is less than 50 nm are excluded, and statistical data of particles corresponding to AR, Round or Solidity displayed as “NaN” is deleted. A sum of “Area” parameters of the particles whose particle size R1 meets R1≥1000 nm and a sum of “Area” parameters of all the particles are calculated and are respectively used as a sum of areas of the particles whose particle size R1 meets R1≥1000 nm and a total area of statistically analyzed particles. The sum of areas of the particles whose particle size R1 meets R1≥1000 nm is divided by the total area of the statistically analyzed particles to obtain the quotient as the area percentage of the particles whose particle size R1 meets R1≥1000 nm in the cross section of the positive electrode film layer in the thickness direction of the electrode plate.

In some embodiments, based on the total area of the particles in the cross section of the positive electrode film layer in the thickness direction of the electrode plate, the area percentage of the particles whose particle size R1 meets R1≥1000 nm is optionally 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, or a value range between any two of the foregoing.

In some embodiments, based on the total area of the particles in the cross section of the positive electrode film layer in the thickness direction of the electrode plate, the area percentage of the particles whose particle size R1 meets R1≥1000 nm ranges from 12% to 40%.

The large particles whose particle size R1 meets R1≥1000 nm help increase the compaction density of the positive electrode plate, thereby increasing the volume energy density of the battery cell. However, researchers find that stress concentration is easily caused at the large particles, and a risk of falling off of the positive electrode film layer is increased. Therefore, the area percentage of the particles whose particle size R1 meets R1≥1000 nm in the cross section of the positive electrode film layer in the thickness direction of the electrode plate is within the range from 12% to 50%, and further, within the range from 12% to 40%, so that not only the compaction density of the electrode plate can be improved, but also a probability of falling off of the film layer is not excessively high. Therefore, a problem of capacity diving is relieved when the energy density of the thick-coating lithium-containing transition metal phosphate battery is improved, and the cycle life of the battery is considered.

In some embodiments, in an area-weighted cumulative distribution curve of sphericity of particles whose particle size R1 meets R1≥1000 nm, L_{R1A50} ranges from 0.6 to 0.8.

In the present application, in a cross section of the positive electrode film layer in a thickness direction of the positive electrode plate, a test method for the sphericity of the particles whose particle size R1 meets R1≥1000 nm is specifically as follows: identifying the particles in the cross section of the positive electrode film layer by using the foregoing method in the present application, and analyzing morphology of the particles in the cross section of the positive electrode film layer in the thickness direction of the positive electrode plate by using a “shape description” analysis function in ImageJ. According to the software manual (ImageJ User Guide IJ 1.46r), an analyzed “Round” parameter represents a ratio of a pixel area of a particle to an area of a circle with a fitted major axis as the diameter, which may be configured to characterize the sphericity of the particle. When the particle is closer to a spherical shape, the ratio of the pixel area to the area of the circle with the fitted major axis as the diameter is closer to 1. Therefore, the “Round” parameter of the particle obtained through analysis is configured to characterize the sphericity of the particle. According to the foregoing method, to meet a statistically significant sample count, at least 10 scanning electron micrographs whose fields of view do not overlap are collected for each electrode plate. Obtained sphericity of at least 1000 particles is sorted in ascending order. The cumulative distribution curve of the sphericity of the particles in the positive electrode film layer is obtained with the sphericity with a horizontal axis and the cumulative area percentage as a vertical axis. L_{A50} is a corresponding L value of sphericity when the cumulative area percentage on the vertical axis is 50% in the L-value cumulative distribution curve of sphericity of the particles.

In some embodiments, in the cross section of the positive electrode film layer in the thickness direction of the positive electrode plate, in the area-weighted cumulative distribution curve of the sphericity of the particles whose particle size R1 meets R1≥1000 nm, L_{R1A50} is optionally 0.60, 0.61, 0.62, 0.63, 0.64, 0.65, 0.66, 0.67, 0.68, 0.69, 0.70, 0.705, 0.71, 0.72, 0.73, 0.74, 0.75, 0.76, 0.77, 0.78, 0.79, 0.80, or a value range between any two of the foregoing.

A person skilled in the art may achieve the regulation of the sphericity of particles through any known process. For example, the adjustment of the sphericity of particles can be achieved through processes such as lapping, polishing, chemical etching, mechanical stirring, extrusion, coating, granulation, and surfactant addition and the adjustment of parameters in the processes.

In some embodiments, in the cross section of the positive electrode film layer in the thickness direction of the positive electrode plate, in the area-weighted cumulative distribution curve of the sphericity of the particles whose particle size R1 meets R1≥1000 nm, L_{R1A50} ranges from 0.65 to 0.75.

In some embodiments, in the cross section of the positive electrode film layer in the thickness direction of the positive electrode plate, in the area-weighted cumulative distribution curve of the sphericity of the particles whose particle size R1 meets R1≥1000 nm, L_{R1A50} ranges from 0.67 to 0.75.

In the cross section of the positive electrode film layer in the thickness direction of the positive electrode plate, in the area-weighted cumulative distribution curve of the sphericity of the particles whose particle size R1 meets R1≥1000 nm, L_{R1A50} is within the range from 0.65 to 0.75, and further, within the range from 0.67 to 0.75, to help further mitigate stress concentration at large particles in the positive electrode film layer of the thick-coating stacked electrode assembly, thereby reducing the probability of falling off of the film layer, and improving the cycle life of the battery.

In some embodiments, in a cumulative distribution curve of a coating value B obtained from the positive electrode film layer in the area mapping mode of the laser microscopic confocal Raman spectrometer, a median B₅₀ of the coating value B ranges from 0.30 to 0.60. The coating value B is I_{P}/I_{D}. I_{P} represents the intensity of the P band at 948=100 cm⁻¹ in Raman spectra, and I_{P} represents the intensity of the D band at 1350+100 cm⁻¹ in Raman spectra.

The cumulative distribution curve of the coating value B value is a curve obtained by sorting at least 100 obtained B values in ascending order and using the coating value as a horizontal axis and the cumulative number percentage as a vertical axis. To reduce the impact of the outliers of the coating value caused by non-particle region in the positive electrode film layer on the test results, the median B₅₀ of the coating value is used to evaluate the density of the carbon coating material on the positive electrode active material. B₅₀ is a corresponding B value when the cumulative number percentage on the vertical axis of the cumulative distribution curve of the coating value B value is 50%.

In the present application, the coating value B value of the positive electrode film layer may be obtained through mapping of the laser microscopic confocal Raman spectrometer. For example, specifically, a laser microscopic confocal Raman spectrometer (high-precision Renishaw laser microscopic confocal Raman spectrometer) is employed, and a 532 nm excitation wavelength is used. An appropriate amount of the positive electrode film layer is subjected to area mapping on the surface of the positive electrode film layer or the cross section of the positive electrode film layer in the thickness direction of the electrode plate. The scanning area is set to 45 μm×45 μm and is divided into a 10×10 grid. Test points are located at grid vertices with a step size of 5 μm, and a total of 100 scan points are obtained. This yields B-values at distinct locations and the cumulative distribution curve of the B-value across the area-mapped region. The positive electrode film layer in the present application may be a freshly prepared positive electrode film layer, or may be a positive electrode film layer disassembled from a battery. Residual electrolyte salt particles inevitably exist on the surface of the positive electrode film layer disassembled from the battery. To improve the test accuracy, area mapping is preferably performed on the cross section of the positive electrode film layer in the thickness direction of the electrode plate, thereby characterizing the coating value of the positive electrode film layer.

The coating value B value of the positive electrode film layer is obtained through the intensity ratio of the P-band to D-band in Raman spectra. The P-band, positioned at 948±100 cm⁻¹, characterizes the phosphate radical PO₄³⁻structure. The D-band, positioned at 1350±100 cm⁻¹, represents disordered structures. The “disorder” refers to the absence of a regular arrangement among carbon atoms in the structure. During testing, a 532 nm excitation wavelength is used, and a test depth is small. Therefore, in test results of the positive electrode film layer in the area mapping mode of the laser microscopic confocal Raman spectrometer, a carbon structure peak exhibits higher strength in comparison with a phosphate radical structure peak.

A person skilled in the art may achieve the regulation of the coating value of particles of the active material through any known process. For example, the adjustment of the coating value of the particles of the active material can be achieved by regulating carbon source types, carbon source addition amounts, sintering temperature, sintering duration, sintering pressure, and sintering atmosphere. The coating value B value can reflect the density of the carbon coating material on the surface of the lithium-containing transition metal phosphate particles. When carbon coating is denser, the strength of the phosphate radical structure detected in Raman spectra is lower, and the positive electrode film layer has a smaller coating value B value.

In some embodiments, the positive electrode film layer further includes a coating layer disposed on at least a portion of the surface of the lithium-containing transition metal phosphate particles, and in the cumulative distribution curve of the coating value B obtained from the positive electrode film layer in the area mapping mode of the laser microscopic confocal Raman spectrometer, the median B₅₀ of the coating value is optionally 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, or a value range between any two of the foregoing.

When the median B₅₀ of the coating value of the positive electrode film layer is within the foregoing range, it indicates that a carbon coating material of a positive electrode active material is dense and uniform, to help improve slip uniformity of the positive electrode film layer during rolling, and mitigate a phenomenon of stress concentration of the thick-coating positive electrode film layer. In addition, through the dense and uniform carbon coating material, the large particles in the positive electrode film layer are more easily slipped during compaction, to mitigate a phenomenon of stress concentration at the large particles in the thick-coating positive electrode film layer, reduce the probability of falling off of the positive electrode film layer, improve the problem of capacity diving of the battery, and improve the cycle life of the battery.

In some embodiments, a single-side thickness H of the positive electrode film layer ranges from 70 μm to 120 μm.

In some embodiments, the single-side thickness H of the positive electrode film layer ranges from 90 μm to 120 μm.

The thickness of the positive electrode film layer may be detected in any manner known in the field. For example, the thickness of the cross section of the positive electrode film layer in the thickness direction of the positive electrode plate is measured by using a scanning electron microscope.

In some embodiments, the single-side thickness H of the positive electrode film layer is optionally 70 μm, 71 μm, 71.53 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99μ, 100μ, 101μ, 102 μm, 103 μm, 104 μm, 105 μm, 105.64 μm, 105.89 μm, 106 μm, 106.66 μm, 106.79 μm, 107 μm, 108 μm, 109 μm, 110 μm, 111 μm, 112 μm, 113 μm, 114 μm, 115 μm, 116 μm, 117 μm, 118 μm, 119 μm, 119.12 μm, 120 μm, or a value range between any two of the foregoing.

During long cycling of the battery, an excessively large thickness of the positive electrode film layer causes large volume expansion, resulting in an increase in internal stress. Consequently, the risk of falling off of the film layer easily occurs in the electrode plate in a later period of the cycling. The single-side thickness of the positive electrode film layer is within the foregoing range, to help further improve a load of the positive electrode active material in the battery, improve a capacity of the battery, and improve the cycle performance of the battery while the risk of falling off of the film layer is considered.

In some embodiments, the single-side thickness H of the positive electrode film layer ranges from 100 μm to 120 μm.

The thickness of the positive electrode film layer is increased to help improve the load of the positive electrode active material and help improve the capacity of the battery. However, it is discovered by an applicant of the present application that, when the single-side thickness of the positive electrode film layer is greater than or equal to 100 μm, in the cycle process of the battery, volume expansion of the positive electrode film layer is more obvious, and consequently, more stress is generated, the phenomenon of stress concentration of the positive electrode film layer is more obvious, and the risk of falling off of the film layer is increased. As a result, the cycle performance of the battery is affected. In this embodiment of the present application, the capacity of the battery is increased by increasing the thickness of the positive electrode film layer, and the median C₅₀ of the graphitization degree in the cumulative distribution curve of the graphitization degree C value obtained from the positive electrode film layer in the area mapping mode of the laser microscopic confocal Raman spectrometer is simultaneously controlled, to improve the slip capability of the particles in the positive electrode film layer, thereby helping mitigate the phenomenon of stress concentration of the film layer and reduce the risk of falling off of the film layer, and further improving the cycle life of the battery.

In some embodiments, the lithium-containing transition metal phosphate particles in the positive electrode film layer include a component shown in the following general formula:

LiₘFeₓP_{y}OⱼQ_{q} Formula I, where
Q includes one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

In some embodiments, m is optionally 0.8, 0.85, 0.9, 0.95, 0.98, 1.00, 1.03, 1.05, 1.08, 1.10, 1.13, 1.15, or a value range between any two of the foregoing; x is optionally 0.9, 0.91, 0.92, 0.93, 0.94, 0.95, 0.96, 0.97, 0.98, 0.99, 1.0, or a value range between any two of the foregoing; y is optionally 0.95, 0.96, 0.97, 0.98, 0.99, 1.00, or a value range between any two of the foregoing; j is optionally 3.5, 3.6, 3.7, 3.8, 3.9, 4, or a value range between any two of the foregoing; and q is optionally 0, 0.01, 0.02, 0.03, 0.04, 0.05, 0.06, 0.07, 0.08, 0.09, 0.1, or a value range between any two of the foregoing.

In some embodiments, the lithium-containing transition metal phosphate particles in the positive electrode film layer include one or more of lithium iron phosphate, lithium manganese phosphate, lithium vanadium fluorophosphate, lithium manganese iron phosphate, and modified materials thereof.

In some embodiments, the lithium-containing transition metal phosphate particles in the positive electrode film layer include one or more of lithium iron phosphate and a doped modified material thereof, and a coating modified material.

In some embodiments, an iron dissolution rate of the positive electrode active material ranges from 658 ppm to 1921 ppm.

The iron dissolution rate of the positive electrode active material can be tested by using a method known in the art. For example, positive electrode material powders of 7.5 g are taken from a sample of the positive electrode film layer through scraping, and are added to 100.3 g of a 0.3% mass concentration ascorbic acid solution (solvent: ultrapure water). The mixture is stirred at 500 revolutions per minute for 305 minutes. The solution is rapidly drawn using a 5 ml syringe. The solution is filtered through a 0.45 μm pore-size filter into a test tube. 1 mL of the supernatant is pipetted into a glass volumetric flask and diluted 50-fold. The diluted solution is tested using inductively coupled plasma optical emission spectrometry (ICP-OES) to determine the iron concentration in the solution. The iron dissolution rate of the positive electrode active material is calculated using the formula: [(ICP-measured iron concentration×solution volume/mass of solution used for dilution)×100.3 g]/(mass of the positive electrode material powders)], where the solution volume is 50 mL and the mass of solution used for dilution is 1 g.

In some embodiments, the iron dissolution rate of the positive electrode active material may be 658 ppm, 700 ppm, 800 ppm, 890 ppm, 900 ppm, 1000 ppm, 1058 ppm, 1076 ppm, 1100 ppm, 1143 ppm, 1200 ppm, 1236 ppm, 1300 ppm, 1311 ppm, 1384 ppm, 1349 ppm, 1400 ppm, 1485 ppm, 1500 ppm, 1531 ppm, 1600 ppm, 1700 ppm, 1800 ppm, 1921 ppm, or a value range between any two of the foregoing.

In some embodiments, the iron dissolution rate of the positive electrode active material ranges from 658 ppm to 1485 ppm.

Iron dissolved from the positive electrode material mainly comes from the lithium-containing transition metal phosphate particles of the positive electrode active material, and the magnitude of the iron dissolution rate depends on the number of lattice defects of the lithium-containing transition metal phosphate in one aspect, and depends on the integrity and density of carbon coating on the surface of the positive electrode active material in another aspect. When the iron dissolution rate is lower, the lithium-containing transition metal phosphate has fewer lattice defects, which is conducive to reducing the corrosion of lattices in a weak acid environment. In addition, when the carbon coating material on the surface of the positive electrode active material is more complete and denser, the dissolution of iron ions in a weak acid environment is inhibited. The positive electrode material with the iron dissolution rate falling within the foregoing range has a relatively small number of lattice defects, and has a complete and dense carbon coating material, which is conducive to improving the compression resistance and the slip propensity of the particles in the positive electrode film layer under large rolling pressure, thereby improving the compaction density of the positive electrode film layer and reducing the stress concentration in the positive electrode film layer, and improving the energy density of the battery while improving the problem of capacity diving of the battery.

In some embodiments, based on a total mass of the lithium-containing transition metal phosphate particles in the positive electrode film layer, a mass content of titanium ranges from 500 ppm to 8000 ppm.

The types and contents of the elements in the lithium-containing transition metal phosphate particles in the positive electrode film layer may be detected in any manner known in the field. For example, titanium and its content are tested using inductively coupled plasma optical emission spectrometry (ICP-OES) in accordance with Appendix C of GB/T 33822-2017.

In some embodiments, based on the total mass of the lithium-containing transition metal phosphate particles in the positive electrode film layer, the mass content of titanium is optionally 500 ppm, 600 ppm, 700 ppm, 800 ppm, 900 ppm, 1000 ppm, 1100 ppm, 1200 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm, or a value range between any two of the foregoing.

In some embodiments, based on the total mass of the lithium-containing transition metal phosphate particles in the positive electrode film layer, the mass content of titanium ranges from 1000 ppm to 3000 ppm.

To introduce titanium into the lithium-containing transition metal phosphate particles, a titanium source needs to be added in a process of preparing the positive electrode active material. The titanium source is usually an inert material, and can achieve the functions of reducing reactivity and suppressing particle dimension growth after being adhered to the surface of lithium-containing transition metal phosphate particle precursors. To improve the graphitization degree of the positive electrode active material, high sintering temperatures or long sintering durations are usually required. However, this also increases the dimensions of the particles in the positive electrode film layer and increases stress concentration of the positive electrode film layer, leading to the falling off of the positive electrode film layer. In this embodiment of the present application, the titanium with a large content is added to the lithium-containing transition metal phosphate particles, so that reactivity of a synthesis raw material of the positive electrode active material is reduced, thereby controlling a proportion of the large particles when the positive electrode active material has a high graphitization degree, mitigating the stress concentration in the positive electrode film layer, reducing the probability of falling off of the positive electrode film layer, and achieving a balance between improving an energy density of the battery and the cycle life of the battery.

In addition, the doping of titanium in the positive electrode active material is conducive to inducing lattice distortion and reducing Li—O bond energy, thereby increasing the transport rate of lithium ions, and improving the kinetic performance of the battery. The diffusion of lithium ions in the thick-coating film layer is not uniform, and is usually accompanied with a significant lithium ionic concentration gradient. In the embodiments of the present application, high-content titanium is added to the lithium-containing transition metal phosphate particles to increase a solid-phase transport rate of the positive electrode active material, thereby mitigating the kinetic issues of the battery with the thick electrode plate.

In some embodiments, based on the total mass of the lithium-containing transition metal phosphate particles in the positive electrode film layer, a mass content of vanadium ranges from 500 ppm to 5000 ppm.

The types and contents of the elements in the lithium-containing transition metal phosphate particles in the positive electrode film layer may be detected in any manner known in the field. For example, vanadium and its content are tested using inductively coupled plasma optical emission spectrometry (ICP-OES) in accordance with Appendix C of GB/T 33822-2017.

In some embodiments, based on the total mass of the lithium-containing transition metal phosphate particles in the positive electrode film layer, the mass content of vanadium is optionally 500 ppm, 600 ppm, 700 ppm, 800 ppm, 900 ppm, 1000 ppm, 1100 ppm, 1200 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3500 ppm, 4000 ppm, 4500 ppm, 5000 ppm.

In some embodiments, based on the total mass of the lithium-containing transition metal phosphate particles in the positive electrode film layer, the mass content of vanadium ranges from 500 ppm to 3000 ppm.

The vanadium in the positive electrode film layer may be in a plurality of valence states. Vanadium of the +5 state (V⁵⁺) may be doped at a site of phosphorus. Due to a large radius of the vanadium of the +5 state, lattice distortion may be caused, and a diffusion channel of lithium ions is expanded, thereby improving ionic conductivity of the positive electrode active material and improving kinetic performance of the battery. Vanadium of the +3 state (V³⁺) may be doped at a site of transition metal, and a lithium vacancy is generated through charge compensation, thereby improving electron conductivity of the positive electrode active material. In addition, distribution uniformity of the vanadium in the lithium-containing transition metal phosphate particles is improved, to help further improve kinetic performance and reaction uniformity of the positive electrode film layer, thereby further improving kinetic performance and cycle performance of the battery cell.

The mass content of vanadium is within the foregoing range, which is conducive to improving the kinetic performance of the positive electrode plate, thereby improving the kinetic performance of the battery with thick-coating lithium-containing transition metal phosphate. In addition, the collaboration of titanium, vanadium, and carbon nanotubes in the positive electrode film layer is conducive to forming an excellent three-dimensional network, to further improve the electron conductivity and the ion conductivity of the positive electrode film layer, thereby further improving the kinetic performance of the battery with thick-coating lithium-containing transition metal phosphate.

In some embodiments, a porosity of the positive electrode film layer ranges from 14% to 28%.

In the present application, the porosity of the positive electrode film layer may be tested in the following manner. The scanning electron micrograph of the cross section of the positive electrode film layer in the thickness direction of the electrode plate obtained in the manner described above is imported into the ImageJ software, Straight Line Tool is selected, use a straight line to mark the scale bar length in the image, and “Analyze Set Scale” is clicked, and a scale bar parameter is set in the software based on the scale bar length in the image. Rectangle Tool is selected to choose the part of the image excluding the scale bar region, “Image Duplicate” is used to duplicate the chosen region, and “Image Type 8 bit” is used to adjust the format of the image. “Analyze Set Measurements” is selected to select the following five options: “Area”, “Mean gray value”, “Area Fraction”, “Limit to threshold”, and “Feret's diameter”. “3” is selected for “Decimal places”, and “Image”, “Adjust”, and “Threshold” are sequentially selected. 0 and 100 are sequentially set within the “Threshold” dialog box, so that pore data in the electron micrograph of the cross section can be exported using the Analyze-Measure function. “Image”, “Overlay”, and “Flatten” are used to export a pore image. “Apply” in “Threshold” is clicked, and then “Analyze” and “Analyze Particles” are clicked to check four columns on the left side, so that the statistical data of pores can be obtained.

It may be understood that a “pore” in the cross section of the positive electrode film layer is identified through image chromatic aberration and thresholds in the embodiments of the present application. The “pores” do not represent porosity data obtained from gas expansion tests, and primarily characterize a gap between particles in the cross section of the positive electrode film layer. This method is superior to the gas expansion method because the porosity obtained from the gas expansion method is associated with inter-particle pores, and is also associated with the pores in the carbon coating material on the surface of the particles, thereby failing to objectively reflect the inter-particle pores.

In some embodiments, the porosity of the positive electrode film layer is optionally 14%, 15%, 16%, 17%, 18%, 19%, 20%, 21%, 22%, 23%, 24%, 25%, 26%, 27%, 28%, or a value range between any two of the foregoing.

The porosity of the positive electrode film layer is within the foregoing range, so that the positive electrode film layer has an electrolyte solution infiltration rate and tortuosity that are good, to help diffusion of a liquid phase and a solid phase of lithium ions, help reduce concentration polarization of a thick electrode plate, and improve the kinetic performance of the battery. In addition, this helps relieve volume expansion of the thick-coating electrode plate in the cycle process, and reduce mechanical stress of the film layer and mitigate the phenomenon of stress concentration, thereby reducing the risk of falling off of the film layer of the thick-coating electrode plate.

Especially, in a thick-coating pouch-type battery, a gap between a housing and an electrode plate is small, and volume occupation of a film layer is large. An accommodating volume of an electrolyte solution is reduced, and a porosity of a positive electrode film layer is within the foregoing range, to help improve a liquid retention rate of an electrode assembly, and improve kinetic performance of the battery.

In some embodiments, a resistivity of the positive electrode film layer ranges from 10 Ω·cm to 35 Ω·cm.

In some embodiments, the resistivity of the positive electrode film layer is 10 Ω·cm, 12 Ω·cm, 14 Ω·cm, 16 Ω·cm, 18 Ω·cm, 20 Ω·cm, 22 Ω·cm, 22 Ω·cm, 24 Ω·cm, 26 Ω·cm, 28 Ω·cm, 30 Ω·cm, 32 Ω·cm, 35 Ω·cm, or a value range between any two of the foregoing.

The resistivity of the positive electrode film layer is within the foregoing range, to help reduce electron transport impedance, reduce charge and discharge polarization, and improve rate performance and the cycle performance of the battery.

In some embodiments, the positive electrode film layer further includes a dispersant, and the dispersant includes hydrogenated nitrile butadiene rubber (HNBR).

HNBR is obtained by hydrogenating butyronitrile rubber to saturate the double bonds. The highly saturated backbone structure of HNBR provides excellent oil resistance, heat resistance, aging resistance, and the like. This enables HNBR to maintain stability as a dispersant in diverse environments and systems, resisting degradation or deterioration while effectively performing the dispersion function. The HNBR molecular chain contains both polar nitrile groups and nonpolar hydrocarbon segments. The polar nitrile groups may interact with some polar materials or a surface of particles, for example, may be attracted to the surface of dispersed particles through hydrogen bonding or electrostatic interactions. The nonpolar hydrocarbon segments have excellent lipophilicity, enabling excellent extension and dispersion in nonpolar or weakly polar media, thereby facilitating uniform dispersion of particles in the media.

After the HNBR is attached to surfaces of particles in a slurry, long-chain molecules of the HNBR form a physical barrier around the particles, to prevent the particles from approaching each other and aggregating, so that the particles maintain in an independent dispersed state in a system. In addition, the HNBR can reduce surface tension between a dispersing medium and the dispersed particles, so that the particles are more easily wetted by the medium, thereby promoting dispersion of the particles in the medium. In addition, the HNBR can further reduce interfacial energy between the particles, and reduce an aggregation phenomenon of the particles that is driven by the interfacial energy. Further, when the slurry is dried into a film, an elastic network structure of the HNBR can buffer shrinking stress generated due to volatilization of a solvent, reduce re-aggregation of the conductive agent due to a capillary force in this process, reduce an area percentage of an aggregation region of the conductive agent, and improve the kinetic performance and the cycle life of the battery.

In some embodiments, based on a mass of the positive electrode film layer, a mass content of the dispersant ranges from 0.5% to 2%.

In some embodiments, based on the mass of the positive electrode film layer, the mass content of the dispersant is optionally 0.5%, 0.6%, 0.7%, 0.8%, 0.9%, 1%, 1.5%, 2%, or a value range between any two of the foregoing.

The mass content of the dispersant is within the foregoing range, so that the particles in the positive electrode film layer can be uniformly dispersed when a high load of the positive electrode film layer is maintained, the stress concentration of the positive electrode film layer with the thick-coating lithium-containing transition metal phosphate is mitigated, and the problem of capacity diving of the battery is effectively relieved.

In some embodiments, the positive electrode film layer further includes a conductive agent. Based on a total area of the cross section of the positive electrode film layer in the thickness direction of the electrode plate, an area percentage of agglomeration regions of the conductive agent ranges from 0.5% to 2.5%.

In the present application, the area percentage of the agglomeration regions of the conductive agent based on the total area of the cross section of the positive electrode film layer in the thickness direction of the electrode plate may be tested using the following method. The cross section of the positive electrode film layer in the thickness direction of the electrode plate is observed through a scanning electron microscope using a method similar to the above. The areas of the agglomeration regions of the conductive agent in the scanning electron micrograph are measured at a magnification of 3k×. Because the conductive agent is usually a carbon-based material, for example, conductive carbon black, or carbon nanotubes, at a high rate of the scanning electron microscope, aggregation of the conductive agent can be seen. In comparison with other regions in the positive electrode film layer, the agglomeration regions of the conductive agent usually exhibit a black agglomeration form. With image analysis software, the agglomeration regions of the conductive agent are regions in which the conductive agent clearly aggregates in the scanning electron micrograph, appearing as black regions. Specifically, the scanning electron micrograph at the magnification of 3k× is imported into ImageJ. Black agglomeration regions of the conductive agent whose Feret is greater than or equal to 2 μm are selected, and a sum of the areas of the selected regions is calculated and denoted as the area of the agglomeration regions of the conductive agent. The area percentage of the agglomeration regions of the conductive agent is a ratio of the area of the agglomeration regions of the conductive agent to the total area of the imported scanning electron micrograph. Three scanning electron micrographs with nonoverlapping ranges are randomly taken, and a mean value of the area percentages of the agglomeration regions of the conductive agent is calculated as “the area percentage of the agglomeration regions of the conductive agent based on the total area of the cross section of the positive electrode film layer in the thickness direction of the electrode plate”.

In some embodiments, the positive electrode film layer further includes the conductive agent. Based on the total area of the cross section of the positive electrode film layer in the thickness direction of the electrode plate, the area percentage of the agglomeration regions of the conductive agent is optionally 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, or a value range between any two of the foregoing.

When the area percentage of the agglomeration regions of the conductive agent is within the foregoing range based on the total area of the cross section of the positive electrode film layer in the thickness direction of the electrode plate, it indicates that the conductive agent is uniformly dispersed in the positive electrode film layer, and an uniform conductive network is easily formed, to particularly help reduce a problem that kinetics of the thick-coating film layer is decreased because an ion transmission path is extended, reduce problems of local polarization and even lithium plating caused in the cycle process of the battery, and improve the cycle life of the battery.

In addition, research shows that large-dimension first particles in the lithium-containing transition metal phosphate particles are prone to springback. When the agglomeration area of the conductive agent is within the foregoing range, the uniform distribution of the conductive agent can inhibit the springback of the lithium-containing transition metal phosphate particles, and mechanical restraining is formed for the particles and even the film layer to improve the cohesive force of the film layer, thereby reducing phenomena of powder falling and falling off of the film layer, and improving the cycle life of the battery.

In some embodiments, the positive electrode film layer further includes the conductive agent. Based on the total area of the cross section of the positive electrode film layer in the thickness direction of the electrode plate, the area percentage of the agglomeration regions of the conductive agent ranges from 1.5% to 2.5%.

In the embodiments of the present application, the area percentage of the agglomeration regions of the conductive agent is further within the foregoing range, indicating that the conductive agent is distributed more uniformly in the positive electrode film layer, and the content of the conductive agent is low, so that while the kinetic performance of the positive electrode film layer is improved, the occupation of the space of the positive electrode active material by the excessive conductive agent is reduced, thereby further improving the volumetric energy density of the battery while improving the kinetic performance of the battery.

In some embodiments, the conductive agent includes carbon nanotubes, and the carbon nanotubes include one or more of single-walled carbon nanotubes, few-walled carbon nanotubes, and multi-walled carbon nanotubes.

In the present application, the term “carbon nanotubes” refers to a nanomaterial including several to dozens of layers concentric hollow tubes, formed by rolling up graphene sheets composed of carbon atoms bonded via sp² hybridization. The diameter usually ranges from several to dozens of nanometers, and the length may range from several micrometers to centimeters, exhibiting a length-diameter ratio. Based on the number of graphene sheets, carbon nanotubes may be classified into single-walled carbon nanotubes (SWCNTs), few-walled carbon nanotubes (FWCNTs), and multi-walled carbon nanotubes (MWCNTs). Based on the number of graphene sheets, carbon nanotubes may be classified into single-walled carbon nanotubes (SWCNTs), few-walled carbon nanotubes (FWCNTs), and multi-walled carbon nanotubes (MWCNTs).

Because the carbon nanotubes have a one-dimensional structure, the carbon nanotubes can form a network structure in the positive electrode film layer. On one hand, a high-elasticity modulus of the carbon nanotubes enables the network structure of the carbon nanotubes to not only serve as a bridge for stress propagation, but also have a binding effect on the thick-coating positive electrode film layer, to suppress bounce of the lithium-containing transition metal phosphate particles, effectively mitigate the stress concentration, and reduce the risk of falling off of the film layer, thereby improving the problem of capacity diving of the battery. On the other hand, excellent electrical conductivity of the carbon nanotubes enables the network structure of the carbon nanotubes to serve as an efficient electron transport channel. Even though the film layer partially falls off, the thick electrode plate can still maintain high electron transport efficiency in an intra-plane direction and the thickness direction, thereby deferring the problem of capacity diving, and further improving the kinetic performance and the cycle life of the battery.

In some embodiments, the conductive agent further includes conductive carbon black.

The conductive carbon black has a large specific surface area, and therefore has a good liquid retention capability. An expansion force of the thick electrode plate in the cycle process is large, so that an electrolyte solution is easily squeezed out. Distribution of the conductive carbon black in the positive electrode film layer helps improve a liquid retention capability of the thick electrode plate, to further relieve a phenomenon of capacity diving of the battery in the cycle process, and improve the cycle life of the battery.

In some embodiments, the agglomeration regions of the conductive agent include carbon nanotubes and conductive carbon black.

Researchers find that carbon nanotubes are prone to an agglomeration phenomenon due to the high surface energy of carbon nanotubes. As a result, the dispersion of carbon nanotubes in the positive electrode film layer is nonuniform, and an effective network structure of carbon nanotubes fails to be formed. Conductive carbon black has surface energy close to that of carbon nanotubes and can be adsorbed on the surface of carbon nanotubes to form a physical barrier, to increase the resistance against the agglomeration of carbon nanotubes and reduce direct contact between carbon nanotubes, thereby further inhibiting the agglomeration phenomenon, and improving the distribution uniformity of carbon nanotubes in the positive electrode film layer. This is conducive to improving the conductivity of the thick-coating positive electrode film layer in one aspect, thereby improving the kinetic performance of the battery, and is conducive to exerting the function of restraining carbon nanotubes on the positive electrode film layer in another aspect, thereby reducing the risk that the thick-coating positive electrode film layer falls off, and further improving the kinetic performance and cycle life of the battery. In addition, the agglomeration of carbon nanotubes in the agglomeration regions of the conductive agent further leads to congestion in a localized ion transport path in the agglomeration regions of the conductive agent, and the combination with conductive carbon black can improve the lithium ion transport capability in the region, thereby reducing localized polarization, and further improving the cycle stability of the battery. In some embodiments, based on the mass of the positive electrode film layer, a mass content C1 of the carbon nanotubes meets: 0<C1≤2.5%, and a mass content C2 of the conductive carbon black meets: 0<C2≤2.5%.

In some embodiments, based on the mass of the positive electrode film layer, the mass content C1 of the carbon nanotubes is optionally 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, or a value range between any two of the foregoing.

In some embodiments, based on the mass of the positive electrode film layer, the mass content C2 of the conductive carbon black is optionally 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, or a value range between any two of the foregoing.

The mass content of the carbon nanotubes and the mass content of the conductive carbon black are within the foregoing range, so that an agglomeration phenomenon of the carbon nanotubes can be effectively relieved, and a good conductive network structure is formed, thereby effectively mitigating the stress concentration of the positive electrode film layer, and improving e a liquid retention rate of the positive electrode plate in the long cycle process, to further reduce the risk of falling off of the film layer in the electrode plate and a polarization degree, achieve a balance between improving the kinetic performance of the battery and the problem of capacity diving, and improve the cycle life of the battery.

In some embodiments, the battery cell further includes a separator 20 disposed between the positive electrode plate and the negative electrode plate. The separator 20 includes a base film 201, a ceramic layer 202 disposed on at least one side of the base film 201, and a bonding layer 203 disposed on a side of the ceramic layer 202 on a side away from the base film 201. The bonding layer 203 is a continuous layer with a porous structure, and the bonding layer 203 includes a vinylidene fluoride-based polymer.

In some embodiments, the battery cell further includes a separator disposed between the positive electrode plate and the negative electrode plate. The separator includes a base film, a ceramic layer disposed on each of two sides of the base film, and a bonding layer disposed on a side of the ceramic layer on at least one side away from the base film.

The ceramic layer is disposed on each of the two sides of the base film, to help improve stiffness of a pouch-type battery, and reduce local stress concentration.

In some embodiments, the battery cell further includes a separator disposed between the positive electrode plate and the negative electrode plate. The separator includes a base film, a ceramic layer disposed on each of two sides of the base film, and a bonding layer disposed on a side of the ceramic layer on each of two sides away from the base film.

In some embodiments, the vinylidene fluoride-based polymer includes one or more of polyvinylidene fluoride (PVDF) and polyvinylidene fluoride-hexafluoropropylene copolymer (PVDF-HFP).

In some embodiments, the vinylidene fluoride-based polymer includes polyvinylidene fluoride (PVDF).

The bonding layer of the separator in existing technologies often uses water-based PVDF, and exhibits an island-like structure in the separator. As shown in FIG. 2, this is conducive to providing gaps for the expansion of the electrode assembly in one aspect, and in one aspect facilitates manufacturing. However, this bonding layer of the separator has a small contact area with the electrode plate, and the bonding force is weak.

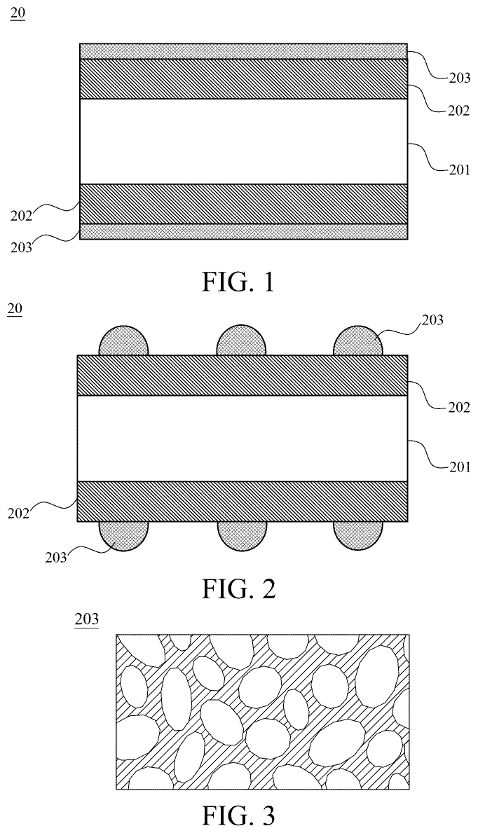

The separator provided in the embodiments of the present application uses the continuous layer with the porous structure as the bonding layer, and as shown in FIG. 1 and FIG. 3, has a larger bonding area with the electrode plate in comparison with the bonding layer in existing technologies, making the bonding between the separator and the electrode plate more secure and uniform, which is further conducive to maintaining the interface contact between the separator and the positive electrode film layer during springback in the positive electrode film layer, thereby reducing the probability that the film layer falls off.

It may be understood that the continuous bonding layer may fracture due to contact or compression with the positive electrode plate or the negative electrode plate and deform into block structures in a manufacturing or cycling process of the electrode plates. The continuous structure in the present application refers to that the bonding layer of the separator is continuous on a microscopic level, for example, as observed under a scanning electron microscope or an optical microscope. To reflect the actual morphology of the separator, during sampling, sampling is preferably performed in a region in which the bonding layer of the separator is not bonded to the positive electrode plate or the negative electrode plate in the battery. For example, sampling is performed at a separator position protruding from the positive electrode plate and the negative electrode plate, or sampling is performed at a separator close to the surface of the electrode assembly. The bonding between the sampling region of the separator and the positive electrode plate or the negative electrode plate is low, and the actual state of the separator can be better reflected.

In comparison with a wound electrode assembly, compression between the separator and the electrode plate in the stacked electrode assembly is smaller, and the separator and the electrode plate easily move relative to each other. As a result, the film layer is easily disturbed, and powder falling and falling off easily occur on the film layer. In addition, lapping between the positive and negative electrodes may be caused, and consequently, a risk of an internal short-circuit of the electrode assembly is increased. Therefore, the separator provided in this embodiment of the present application is especially applicable to the stacked electrode assembly. A bonding force between the porous bonding layer and the electrode plate is increased, to help increase a bonding force between the separator and the electrode plate, and reduce relative displacement between the separator and the electrode plate. This not only helps reduce disturbance to the positive electrode film layer and reduce the risk of falling off of the film layer, but also helps reduce the risk of the short-circuit of the electrode assembly caused by the lapping between the positive and negative electrodes.

In conclusion, when being selected from the foregoing materials, the vinylidene fluoride-based polymer in the bonding layer of this embodiment of the present application helps form the continuous and uniform porous bonding layer. First, the bonding force between the bonding layer and the electrode plate is improved and uniformly distributed, to help mitigate the phenomenon of the stress concentration of the positive electrode film layer with the thick-coating lithium-containing transition metal phosphate, and reduce the risk of falling off of the film layer, thereby helping further improve the cycle life of the battery. Secondly, the bonding layer is stably bonded to the positive electrode plate or the negative electrode plate, to help reduce direct contact between the positive electrode plate and the negative electrode plate caused by the relative displacement between the electrode plate and the separator, and reduce the risk of the internal short-circuit, thereby helping improve safety performance of the battery. In addition, the porous bonding layer helps maintain a porosity of the separator, and reserve space for expansion of the electrode assembly, thereby further improving the cycle life of the battery.

In some embodiments, the material of the base film may include, but is not limited to, one or more of glass fiber, non-woven fabric, polyethylene (PE), and polypropylene (PP).

In some embodiments, the ceramic layer includes one or more of aluminum oxide (Al₂O₃), zirconium oxide (ZrO₂), titanium oxide (TiO₂), silicon oxide (SiO₂), and boron nitride (BN).

Ceramic particles exhibit flame retardancy and high hardness values, demonstrating minimal deformation under thermal stress, thereby exhibiting excellent dimensional stability. The low thermal conductivity of ceramic materials can further prevent localized thermal runaway points in the battery from escalating into full-scale thermal runaway, thereby enhancing the safety performance of the battery cell.

In some embodiments, a thickness of the base film in the separator ranges from 7 μm to 9 μm.

In some embodiments, the thickness of the base film in the separator is optionally 7 μm, 7.5 μm, 8 μm, 8.5 μm, 9 μm, or a value range between any two of the foregoing.

In some embodiments, a single-side thickness of the ceramic layer in the separator ranges from 2 μm to 4 μm.

In some embodiments, the single-side thickness of the ceramic layer in the separator is optionally 2 μm, 2.5 μm, 3 μm, 3.5 μm, 4 μm, or a value range between any two of the foregoing.

In some embodiments, a single-side thickness of the bonding layer in the separator ranges from 1 μm to 5 μm.

In some embodiments, the single-side thickness of the bonding layer in the separator is optionally 1 μm, 1.5 μm, 2 μm, 2.5 μm, 3 μm, 3.5 μm, 4 μm, 4.5 μm, 5 μm, or a value range between any two of the foregoing.

In the present application, the “thickness” has a meaning well-known in the art, and may be tested by using methods and Instruments well-known in the art. For example, the thickness may be tested by using a high-precision micrometer (for example, a Mitutoyo 293-100 type with a precision of 0.1 μm).

When the thickness of the bonding layer is excessively small, void space in the separator is small, and the bonding force between the separator and the electrode plate is low. On one hand, after the film layer expands, stress increases, and the probability of falling off of the film layer increases, affecting the cycle life of the battery. On the other hand, a probability of the short-circuit caused by the lapping between the positive and negative electrodes increases, affecting the safety performance of the battery. When the thickness of the bonding layer is excessively large, a space occupation rate of the battery is large, and consequently, the volume energy density of the battery is affected. In this embodiment of the present application, the thickness of the bonding layer is within the foregoing range, to help achieve a balance between the cycle life, the safety performance, and the volume energy density of the battery.

In some embodiments, a base coating layer is disposed in a bottom region of the positive electrode film layer close to the positive electrode current collector. The base coating layer includes a conductive agent and a binder. The conductive agent includes carbon nanotubes and conductive carbon black. The binder includes a polyvinylidene fluoride (PVDF).

In some embodiments, a thickness of the base coating layer ranges from 0.5 μm to 5 μm.

In some embodiments, the thickness of the base coating layer is optionally 0.5 μm, 1 μm, 1.5 μm, 2 μm, 2.5 μm, 3 μm, 3.5 μm, 4 μm, 4.5 μm, 5 μm, or a value range between any two of the foregoing.

The base coating layer provided in this embodiment of the present application helps improve a bonding force between the positive electrode film layer and the positive electrode current collector, and mitigate the phenomenon of stress concentration at the large particles, thereby reducing the probability of falling off of the positive electrode film layer and improving cycle stability of the battery. In addition, in comparison with that the positive electrode current collector is in direct contact with the positive electrode film layer, a contact area between the base coating layer and the positive electrode film layer is increased, to help increase an area for electron transport between the current collector and the positive electrode film layer, thereby reducing internal resistance of the electrode plate and improving the kinetic performance of the battery.

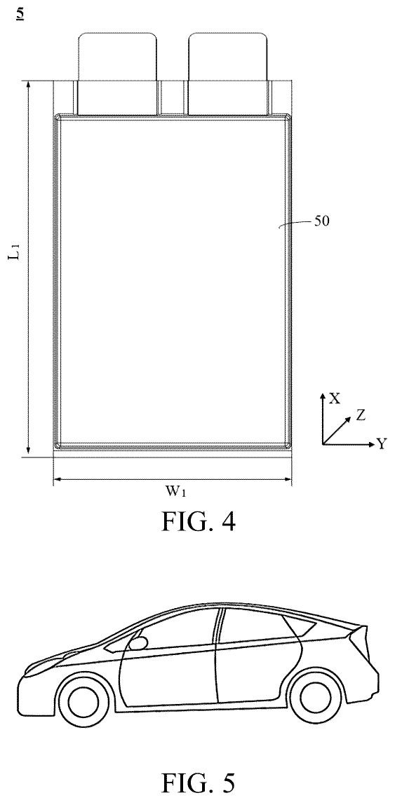

In some embodiments, as shown in FIG. 4, a battery cell 5 includes a housing 50. A stacked electrode assembly is accommodated in the housing 50. A dimension of the housing 50 in a length direction X is L0. A dimension of the housing 50 in a width direction Y is W0. A dimension of the housing 50 in the thickness direction Z is H0. 480 mm≤L0≤720 mm, 100 mm≤W0≤150 mm, and 14 mm≤H0≤22 mm.

In some embodiments, L0 is optionally 480 mm, 490 mm, 500 mm, 510 mm, 520 mm, 530 mm, 540 mm, 550 mm, 560 mm, 570 mm, 580 mm, 590 mm, 600 mm, 610 mm, 620 mm, 630 mm, 640 mm, 650 mm, 660 mm, 670 mm, 680 mm, 690 mm, 700 mm, 710 mm, 720 mm, 750 mm, 800 mm, 850 mm, 900 mm, 950 mm, 1000 mm, 1050 mm, 1100 mm, 1150 mm, 1200 mm, 1250 mm, 1300 mm, or a value range between any two of the foregoing.

In some embodiments, W0 is optionally 100 mm, 110 mm, 120 mm, 130 mm, 140 mm, 150 mm, or a value range between any two of the foregoing.

In some embodiments, H0 is optionally 14 mm, 15 mm, 16 mm, 17 mm, 18 mm, 19 mm, 20 mm, 21 mm, 22 mm, or a value range between any two of the foregoing.

In some embodiments, the dimension of the housing in the length direction is L0, and 450 mm≤L0≤650 mm.

When the dimension L0 of the housing in the length direction meets 450 mm≤L0≤650 mm, a length of the battery cell is small, to help shorten a current diffusion path and reduce the internal resistance of the electrode plate, thereby reducing heat generation of the battery and improving the kinetic performance of the battery. In addition, the small length of the housing helps shorten a diffusion path of the electrolyte solution in an infiltration process, and improve an infiltration rate and uniformity of the electrolyte solution, to further promote deintercalation uniformity of lithium ions in the cycle process, mitigate the phenomenon of stress concentration, reduce the risk of falling off of the film layer, and improve cycle stability of the battery cell.

In some embodiments, the dimension of the housing in the length direction is L0, and 900 mm≤L0≤1300 mm.

When the dimension L0 of the housing in the length direction meets 900 mm≤ L0≤1300 mm, a dimension of the battery cell is long, to help reduce a volume of the housing in the battery cell, and improve a load ratio of the active material. In addition, the long battery cell can reduce a quantity of batteries required in a battery module, simplify a structural design of the battery module, and reduce a quantity and complexity of structural members in the module, thereby improving space utilization of a battery pack, and further helping improve the volume energy density of the battery cell.

In some embodiments, as shown in FIG. 4, the housing 50 is made of a pouch-type material. The pouch-type material includes an aluminum laminate composite film, and optionally, includes a composite film formed by aluminum and one or more of polypropylene (PP), polybutylene terephthalate (PBT), polybutylene succinate (PBS), nylon, polyethylene terephthalate (PET), and polyethylene (PE).

It is discovered by the applicant that, in comparison with hard shell materials such as an aluminum shell and a steel shell, the pouch-type material has a light mass, which is conducive to further improving the energy density of the battery with lithium-containing transition metal phosphate. In addition, the pouch-type material has a high elongation. Therefore, the housing of the pouch-type material is lighter, thinner, and more flexible, to help improve space utilization of the battery cell, thereby improving the energy density of the battery cell. In addition, a high barrier property of the aluminum can effectively reduce infiltration of water and oxygen into the battery, and reduce decomposition of an electrolyte solution and an oxidation degree of an electrode material, thereby improving a life of the battery.

In some embodiments, still refer to FIG. 4, the housing 50 includes a first sealing zone 51, and the first sealing zone 51 is disposed at at least one end of the stacked electrode assembly extending along the width direction. The first sealing zone 51 includes a folded edge structure extending along the length direction. A sealing adhesive is disposed on the folded edge structure. The sealing adhesive is continuously disposed in the length direction and secures the folded edge structure.

The folded edge structure refers to a strengthened structure formed by folding a sealing region in half, and a quantity of times of folding is not limited. For example, the folded edge structure may be a single folded edge structure formed by folding the sealing region once, or may be a double folded edge structure formed by folding two sides of the sealing region.

An SEI film of the positive electrode film layer may be thickened in the cycle process of the electrode plate. Therefore, large springback and gas generation may be caused in the long cycle process. A sealing zone of a pouch-type electrode assembly is used for sealing an electrode assembly, but strength of the sealing zone is limited, and is easily ruptured by the large springback and high gas generation in the film layer.

In the embodiments of the present application, the first sealing zone includes the folded edge structure extending along the length direction, thereby further improving sealing strength of the first sealing zone. In comparison with that the sealing adhesive is discontinuously disposed in the length direction, when the sealing adhesive is continuously disposed in the length direction and secures the folded edge structure, the sealing strength can be further improved, thereby implementing continuous securing of the sealing zone in the length direction, and reducing a probability that the thick-coating electrode plate ruptures the sealing zone in a package in the cycle process.

In some embodiments, the housing 50 includes at least one second sealing zone 52. The second sealing zone 52 is disposed at at least one end of the stacked electrode assembly in the length direction of the housing, and the second sealing zone 52 is disposed on a tab side of the stacked electrode assembly.

It may be understood that the positive electrode tab and the negative electrode tab may be disposed on the same side of the stacked electrode assembly, as shown in FIG. 1, or may be disposed on different sides of the stacked electrode assembly.

In some embodiments, the battery cell 5 further includes a terminal 53. The terminal 53 is connected to a tab of the battery cell. For example, the terminal 53 may be soldered to the tab. The terminal 53 is a conductive member. The terminal 53 is at least partially located outside the housing 50. The terminal 53 is used as an electrode leading-out end of the battery cell 5. The terminal 53 is configured to facilitate the electrical connection between the battery cell 5 and another battery cell 5 or another component. For example, the terminal 53 may have a sheet shape.

Correspondingly, the terminal 53 also includes a positive electrode terminal and a negative electrode terminal, the positive electrode terminal is connected to the positive electrode tab, and the negative electrode terminal is connected to the negative electrode tab.

In some embodiments, the second sealing zone is disposed on the tab side. The tab and a terminal need to be connected to each other. The connection strength between the terminal and the housing material is relatively weak, making it easy for gas to vent through the second sealing zone, which is conducive to achieving directional pressure relief for the battery, thereby reducing the impact on an adjacent electrode assembly during thermal runaway, and improving an overall service life of the battery.

In some embodiments, an outer periphery of the stacked electrode assembly is provided with a plurality of adhesive rings surrounding along the width direction, and the adhesive rings surrounding along the width direction are disposed at intervals along the length direction.

The adhesive rings surrounding along the width direction of the electrode assembly are arranged at intervals along the length direction, to help fix positions of the electrode plates in the electrode assembly, and reduce a probability of displacement of the electrode assembly in a shaking process of the battery. This arrangement is especially applicable to a battery with a large length, and can effectively reduce a lithium plating phenomenon caused by mutual displacement of the electrode plates in the length direction, to help maintain structural stability of space inside the battery, so that normal working of the battery is not affected.

In some embodiments, at 25 °C, a capacity of the battery cell ranges from 95 Ah to 300 Ah.

In some embodiments, at 25 °C, the capacity of the battery cell ranges from 150 Ah to 180 Ah.

In the present application, the capacity of the battery cell has a meaning well-known in the art, and can be tested by using a method known in the art. For example, at 25 °C, the battery is charged at a charging rate of 0.5 C based on the nominal capacity until the voltage reaches 3.65 V, followed by constant-voltage charging at 3.65 V until the current drops to 0.05 C. After a 10-minute rest, the battery is discharged at a discharging rate of 1 C until the voltage drops to 2.5 V, followed by another 10-minute rest. The discharge capacity C (in Ah) is calculated using the formula C=I*t.

In some embodiments, at 25 °C, the capacity of the battery cell is optionally 95 Ah, 100 Ah, 105 Ah, 107 Ah, 110 Ah, 115 Ah, 120 Ah, 125 Ah, 130 Ah, 135 Ah, 140 Ah, 145 Ah, 150 Ah, 155 Ah, 160 Ah, 161 Ah, 162 Ah, 163 Ah, 164 Ah, 165 Ah, 170 Ah, 175 Ah, 180 Ah, 182 Ah, 185 Ah, 190 Ah, 200 Ah, 210 Ah, 220 Ah, 230 Ah, 240 Ah, 250 Ah, 270 Ah, 280 Ah, 290 Ah, 300 Ah, or a value range between any two of the foregoing.

In some embodiments, the positive electrode current collector may be a metal foil or a composite current collector. For example, as the metal foil, an aluminum foil may be used. The composite current collector can include a polymer material substrate and a metal layer formed on at least one surface of the polymer material substrate. The composite current collector may be formed by forming a metal material (aluminum, an aluminum alloy, nickel, a nickel alloy, titanium, a titanium alloy, silver, a silver alloy, or the like) on a polymer material substrate (for example, a substrate of polypropylene (PP), polyethylene terephthalate (PET), polybutylene terephthalate (PBT), polystyrene (PS), or polyethylene (PE)).

In some implementations, the negative electrode current collector may use a metal foil or a composite current collector. For example, as a metal foil, copper foil may be used. The composite current collector can include a polymer material substrate and a metal layer formed on at least one surface of the polymer material substrate. The composite current collector can be formed by forming a metal material (copper, copper alloy, nickel, nickel alloy, titanium, titanium alloy, silver and silver alloy, etc.) on a high molecular material substrate (such as polypropylene (PP), polyethylene terephthalate (PET), polybutylene terephthalate (PBT), polystyrene (PS), and polyethylene (PE)).

In some embodiments, the negative electrode film layer includes a negative electrode active material. As an example, the negative electrode active material may include at least one of the following materials: artificial graphite, natural graphite, soft carbon, and hard carbon. However, the present application is not limited to such materials, and may alternatively use other conventional materials that can be used as negative electrode active materials for batteries. Only one or a combination of two or more of these negative electrode active materials may be used.

In some implementations, the negative electrode film layer optionally includes a binder. The binder may be at least one selected from styrene-butadiene rubber (SBR), polyacrylic acid (PAA), polyacrylic acid sodium (PAAS), polyacrylamide (PAM), polyvinyl alcohol (PVA), sodium alginate (SA), poly(methyl methacrylate) (PMAA), and carboxymethyl chitosan (CMCS).

In some implementations, the negative electrode film layer optionally includes another adjuvant such as a thickener (for example, sodium carboxymethyl cellulose (CMC-Na)).

In some implementations, the negative electrode plate may be prepared in the following manner: dispersing components for preparing the negative electrode plate, for example, a negative electrode active material, a conductive agent, a binder, and any other components into a solvent (for example, deionized water) to form negative electrode slurry; coating the negative electrode slurry on the negative electrode current collector to obtain the negative electrode plate subsequent to procedures such as drying and cold pressing.

According to a second aspect of the present application, a battery apparatus is provided, including the battery cell in the first aspect of the present application.

The battery apparatus disclosed in the embodiments of the present application may be used in a power consuming device that uses a battery apparatus as a power supply or used in various energy storage systems that use a battery apparatus as an energy storage element. The battery apparatus may be used in a vehicle, and may further be used in, but is not limited to, a mobile phone, a tablet computer, a laptop computer, an electric toy, an electric tool, an electric scooter, an electric vehicle, a ship, spacecraft, or the like. The electric toy may be a stationary or mobile electric toy, for example, a game console, an electric vehicle toy, an electric ship toy, or an electric aircraft toy. The spacecraft may include an airplane, a rocket, a space shuttle, a spaceship, and the like.

According to a third aspect of the present application, a power consuming apparatus that uses a battery apparatus as a power supply is provided. The power consuming apparatus includes at least one of the battery cell, the battery module, or the battery pack provided in the present application. The battery cell, the battery module, or the battery pack may be used as a power supply of the power consuming apparatus or may be used as an energy storage unit of the power consuming apparatus. The battery cell, the battery module, or the battery pack may be selected according to use requirements of the power consuming apparatus.

FIG. 5 shows a power consuming apparatus as an example. The power consuming apparatus disclosed in the embodiments of the present application may be a fuel powered vehicle, a gas powered vehicle, or a new energy vehicle. The new energy vehicle may be a pure electric vehicle, a hybrid electric vehicle, or an extended range vehicle, etc. A battery apparatus is provided inside the vehicle. The battery apparatus may be disposed at the bottom, head, or tail of the vehicle. The battery apparatus may be configured to supply power to the vehicle. For example, the battery apparatus may be used as a power source for operating the vehicle. The vehicle may further include a controller and a motor. The controller is configured to control the battery apparatus to supply power to the motor, for example, to meet working power requirements during starting, navigation, and traveling of the vehicle. In some embodiments of the present application, the battery apparatus can not only serve as a power supply for operating the vehicle, but can also serve as a power supply for driving the vehicle, in place of or partially in place of fuel or natural gas, to provide driving power for the vehicle.

According to a fourth aspect of the present application, an energy storage apparatus that uses a battery apparatus as a power supply is provided. The energy storage apparatus may be, but is not limited to, an energy storage container, an energy storage cabinet, an energy storage power station, an energy storage battery pack, or a portable energy storage system.

### EXAMPLES

Examples of the present application will be described hereinafter. The examples described below are exemplary and only used to explain the present application, and should not be construed as a limitation on the present application. If the specific technology or conditions are not specified in the examples, the technology or conditions described in the literature in this field or the product manual shall be followed. The used reagents or instruments without manufacturer indicated are all conventional products that may be purchased in the market.

### Example 1

### (1) Preparation of a Positive Electrode Active Material

Lithium dihydrogen phosphate, ferrous oxalate, a carbon source, titanium dioxide, and vanadium pentoxide were uniformly mixed and ground in methanol to obtain mixed raw materials. The ratio of lithium dihydrogen phosphate to ferrous oxalate was controlled to achieve a lithium-to-iron molar ratio of 1.025:1.0. The carbon source includes polyethylene glycol with a weight average molecular weight of 500, polyethylene glycol with a weight average molecular weight of 2000, and polyethylene glycol with a weight average molecular weight of 4000 whose mass ratio is 2:6:2. The ferrous oxalate exhibits a particle size D₁₀=6.5 μm, a particle size D₅₀=62 μm, and a particle size D₉₀=108 μm. In the ferrous oxalate, the mass content of Fe is 30.5%, and the mass content of trivalent iron is 0.03%.

The mixed raw materials underwent multiple rounds of ball milling in a ball mill, followed by demagnetization to obtain the mixed slurry. The number of grinding cycles and grinding duration were controlled to achieve a particle size Dv₅₀ of 3.15 μm in the ground mixed slurry.

The mixed slurry was spray-dried to yield dried precursor powder, which exhibits a uniform light-yellow appearance.

The precursor powder was placed in a sintering furnace, was heated from 25 °C to 360 °C under nitrogen atmosphere at 2 °C/min and maintained at the temperature for 3.5 h, was then heated to a second temperature of 785 °C at 5 °C/min and maintained at the temperature for 10 h, and was cooled upon completion. Based on the total mass of the positive electrode active material, the mass content of Ti is 1050 ppm, and the mass content of V is 950 ppm.

The obtained material was pulverized using an airflow pulverization method with a classification frequency of 21 Hz and a grinding air pressure of 0.54 MPa, yielding the positive electrode active material of lithium iron phosphate with carbon coated.

D₁₀, D₅₀, D₉₀, and Dv₅₀ are data tested using a Malvern laser scattering method.

### (2) Preparation of a Positive Electrode Plate

The positive electrode active material, conductive agent, and polyvinylidene fluoride binder were mixed in a mass ratio of 94.1:1.9:3 using N-methylpyrrolidone as the solvent, and a dispersant HNBR with a mass ratio of 1% was added. The mixture was thoroughly blended, stirred, and dispersed in a stirring tank to form positive electrode slurry. Upon completion of the stirring process, the positive electrode slurry was transferred to the coating process. The conductive agent consists of conductive carbon black and multi-walled carbon nanotubes in a 0.9:1 mass ratio. The carbon black exhibits a specific surface area of 80 m²/g and an oil absorption value of 180 mL/100 g, and the carbon nanotubes have an average length of 20 μm and a specific surface area of 280 m²/g.

The positive electrode slurry was coated, through extrusion, onto an aluminum foil for drying, and cold pressing was performed to obtain a positive electrode plate with a single-side thickness H of 105.64 μm and a positive electrode plate with a compaction density of 2.36 g/cm³ of the positive electrode film layer. The compaction density is a compaction density when the battery cell is in the fully-discharged state.

The positive electrode plates were slit and punched into specified shapes. The punched positive electrode plates were then sorted by weight using a weight sorting machine for stacking by a stacking machine.

In the cross section of the positive electrode film layer in the thickness direction of the electrode plate, in the area-weighted cumulative distribution curve of sphericity of the particles whose particle size R1 meets R1≥1000 nm, the median L_{R1A50} of sphericity is 0.72; the median C₅₀ of the graphitization degree of the positive electrode film layer is 1.12; the concentration degree (C₉₀-C₁₀)/C₅₀ of the graphitization degree C value is 0.025; based on the total area of the particles in the cross section of the positive electrode film layer in the thickness direction of the electrode plate, the area percentage of the particles whose particle size R1 meets R1≥1000 nm is 35.28%; the median B₅₀ of the coating value B of the positive electrode film layer is 0.441; the iron dissolution rate of the positive electrode material is 976 ppm; the area percentage of the agglomeration regions of the conductive agent based on the total area of the cross section of the positive electrode film layer in the thickness direction of the electrode plate is 1.91%; the porosity of the positive electrode film layer is 15.06%; and the film resistivity of the positive electrode film layer is 31.0 Ω·cm.

### (3) Preparation of a Negative Electrode Plate

The negative electrode slurry was prepared by homogeneously mixing a 1:1 weight ratio blend of artificial graphite and natural graphite, conductive agent (conductive carbon black), styrene-butadiene rubber (SBR) binder, and sodium carboxymethyl cellulose (CMC) thickener in the weight percentages of 96:0.5:2.0:1.5 in deionized water. After stirring and dispersion, the negative electrode slurry was coated onto a copper foil substrate. After drying, cold pressing, slitting, and tab formation, the negative electrode plate is obtained.

The negative electrode plates were slit and punched into specified shapes. The punched negative electrode plates were then sorted by weight using a weight sorting machine for stacking by a stacking machine.

### (4) Separator

Polyvinylidene fluoride (PVDF) was dissolved in N-methylpyrrolidone (NMP) and stirred uniformly, polyethylene glycol (PEG) was then added as a pore-forming agent, and after thorough stirring and mixing, a bonding layer solution was obtained. The bonding layer solution was coated onto the base film with ceramic layers on both sides. After pre-volatilization at 80 °C and drying at 110 °C, the coated base film was immersed in deionized water to leach out the PEG, to obtain a separator with a bonding layer having a porous structure.

The thickness of the base film is 8 μm, the thickness of the single-side ceramic layer is 3 μm, and the thickness of the single-side bonding layer is 1 μm.

### (5) Electrolyte

Under argon atmosphere in a glove box (H₂O<0.1 ppm and O₂<0.1 ppm), organic solvents dimethyl carbonate (DMC), ethyl methyl carbonate (EMC), and ethylene carbonate (EC) were homogeneously mixed.

Lithium hexafluorophosphate was then added and dissolved in the organic solvent to achieve a lithium hexafluorophosphate concentration of 1.05 mol/L, and vinylene carbonate (VC) was added and homogeneously stirred to obtain the electrolyte in Example 1.

As calculated based on the total mass of the electrolyte, the mass content of dimethyl carbonate is 26%, the mass content of ethyl methyl carbonate is 43.3%, the mass content of ethylene carbonate is 17.3%, and the mass content of vinylene carbonate is 0.9%.

### (6) Preparation of a Battery

The positive electrode plate, the separator, and the negative electrode plate are stacked in sequence using the stacking machine. The separator needs to achieve the function of isolating the positive and negative electrodes to obtain the stacked electrode assembly. Taping treatment is performed on the stacked electrode assembly to tightly encapsulate the electrode assembly. The taped stacked electrode assembly was placed in an outer package. The outer package is made of an aluminum laminate film that is a pouch-type material. The aluminum laminate film is a composite structure composed of an inner polypropylene layer, a middle aluminum foil layer, and an outer nylon layer. The outer package of the aluminum laminate film underwent processing via a pocket forming machine and trimming to obtain the target shape and dimensions. Subsequently, the aluminum laminate film was thermally encapsulated to meet the sealing strength of the aluminum laminate film≥25 N/8 mm. The battery underwent vacuum baking and resting. An electrolyte solution was then injected, followed by encapsulation. Subsequently, the pouch-type battery underwent hot pressing and cold pressing operations. The hot pressing was performed at 45 °C for 2 minutes under a pressure of 90 kg/cm². The cold pressing was performed at 25 °C for 2 minutes under a pressure of 90 kg/cm²). Finally, after processes such as formation, degassing, and trimming, the battery cell was obtained. The battery cell has a dimension of 600 mm in the length direction, a dimension of 125 mm in the width direction, and a dimension of 20 mm in the thickness direction.

The preparation methods in Examples 2 to 10 are basically the same as the preparation method in Example 1, and a difference lies in that the method for preparing a positive electrode active material is adjusted, and details are as follows.

### Example 2

The preparation method in Example 2 is basically the same as the preparation method in Example 1, and a difference lies in that the second temperature was adjusted to 765 °C during preparation of the positive electrode active material.

### Example 3

The preparation method in Example 3 is basically the same as the preparation method in Example 1, and a difference lies in that the second temperature was adjusted to 735 °C during preparation of the positive electrode active material.

### Example 4

The preparation method in Example 4 is basically the same as the preparation method in Example 1, and a difference lies in that the carbon source was replaced with polyethylene glycol with a weight average molecular weight of 500 and polyethylene glycol with a weight average molecular weight of 2000 whose mass ratio is 2:8 during preparation of the positive electrode active material.

### Example 5

The preparation method in Example 5 is basically the same as the preparation method in Example 1, and a difference lies in that the carbon source was replaced with polyethylene glycol with a weight average molecular weight of 500 during preparation of the positive electrode active material.

### Example 6

The preparation method in Example 6 is basically the same as the preparation method in Example 1, and a difference lies in that the carbon source was replaced with polyethylene glycol with a weight average molecular weight of 2000 during preparation of the positive electrode active material.

### Example 7

The preparation method in Example 7 is basically the same as the preparation method in Example 3, and a difference lies in that the carbon source was replaced with polyethylene glycol with a weight average molecular weight of 500 and glucose whose mass ratio is 2:8 during preparation of the positive electrode active material.

### Example 8

The preparation method in Example 8 is basically the same as the preparation method in Example 1, and a difference lies in that a coating weight was adjusted, and parameters, such as a thermal rolling pressure, a thermal rolling temperature, a speed of coating transfer, and a heating temperature before thermal rolling and compaction was performed for the first time, was adaptively adjusted during preparation of the positive electrode plate, to adjust the compaction density of the positive electrode plate.

### Example 9

The preparation method in Example 9 is basically the same as the preparation method in Example 1, and a difference lies in that, during preparation of the positive electrode plate, a coating weight was adjusted, so that the single-side thickness H of the positive electrode film layer obtained through cold pressing was 119.12 μm; and the thickness of the battery was properly adjusted, so that quantities of positive electrode plates, separators, and negative electrode plates simultaneously remain unchanged.

### Example 10

The preparation method in Example 10 is basically the same as the preparation method in Example 1, and a difference lies in that, during preparation of the positive electrode plate, a coating weight was adjusted, so that the single-side thickness H of the positive electrode film layer obtained through cold pressing was 71.53 μm; and the thickness of the battery was properly adjusted, so that quantities of positive electrode plates, separators, and negative electrode plates simultaneously remain unchanged.

### Comparative Example 1

The preparation method in Comparative example 1 is basically the same as the preparation method in Example 7, and a difference lies in that the carbon source was replaced with glucose during preparation of the positive electrode active material.

### Test Methods:

### 1. Capacity of a Lithium-Ion Secondary Battery Cell

At 25 °C, the battery is charged at a charging rate of 0.5 C based on the nominal capacity until the voltage reaches 3.65 V, followed by constant-voltage charging at 3.65 V until the current drops to 0.05 C. After a 10-minute rest, the battery is discharged at a discharging rate of 1 C until the voltage drops to 2.5 V, followed by another 10-minute rest. The discharge capacity C (in Ah) is calculated using the formula C=I*t.

### 2. Quantity of Cycles Corresponding to a Capacity Decayed to 80%

At 25 °C, the battery is charged at a charging rate of 0.5 C based on the nominal capacity until the voltage reaches 3.65 V, followed by constant-voltage charging at 3.65 V until the current drops to 0.05 C. After a 10-minute rest, the battery is discharged at a discharging rate of 1 C until the voltage drops to 2.5 V, followed by another 10-minute rest. The charging and discharging is one cycle. Testing is stopped until the capacity of the battery was decayed to 80% of the nominal capacity, and a quantity of cycles is denoted as @80% SOH.

### Test Results

The test results of each example and comparative example are shown in table 1.

TABLE 1
Preparation parameters of Examples and Comparative examples

| | Positive electrode film layer | | | | | | |
|---|---|---|---|---|---|---|---|
| | | | | | Median | | |
| | | | | | L_{R1A50} of | | |
| | | | | | sphericity in | | |
| | | | | | an area- | | |
| | | | | | weighted | | |
| | | | | | cumulative | | |
| | | | | | distribution | | |
| | | | | | curve of | | |
| | | | | Concentration | sphericity of | | |
| | | | | degree | particles | | |
| | Single- | | | (C₉₀ − C₁₀)/ | whose | Battery | |
| | side | | Median C₅₀ of a | C₅₀ of | particle size | @80% | |
| | thickness | Compaction | graphitization | graphitization | R1 meets | SOH | Capacity |
| | (μm) | density (g/cm³) | degree | distribution | R1 ≥ 1000 nm | (cycles) | (Ah) |
| Example 1 | 105.64 | 2.36 | 1.11 | 0.025 | 0.72 | 2107 | 160 |
| Example 2 | 105.89 | 2.36 | 1.02 | 0.039 | 0.70 | 2040 | 159 |
| Example 3 | 105.89 | 2.36 | 1.01 | 0.039 | 0.67 | 2018 | 158 |
| Example 4 | 106.66 | 2.36 | 1.07 | 0.035 | 0.72 | 2097 | 161 |
| Example 5 | 106.79 | 2.36 | 1.03 | 0.035 | 0.72 | 2075 | 160 |
| Example 6 | 106.79 | 2.36 | 1.06 | 0.036 | 0.72 | 2089 | 160 |
| Example 7 | 106.79 | 2.36 | 0.96 | 0.045 | 0.67 | 1998 | 160 |
| Example 8 | 105.65 | 2.52 | 1.13 | 0.024 | 0.72 | 2095 | 170 |
| Example 9 | 119.12 | 2.36 | 1.13 | 0.023 | 0.72 | 2090 | 178 |
| Example 10 | 71.53 | 2.36 | 1.11 | 0.025 | 0.72 | 2118 | 95 |
| Comparative | 105.64 | 2.36 | 0.93 | 0.053 | 0.67 | 1953 | 158 |
| example 1 | | | | | | | |

As can be seen from comparison between Examples 1 to 10 and Comparative example 1, a battery cell includes a stacked electrode assembly. The stacked electrode assembly includes a positive electrode plate and a negative electrode plate. The positive electrode plate includes a positive electrode current collector and a positive electrode film layer disposed on at least one side of the positive electrode current collector. The positive electrode film layer includes lithium-containing transition metal phosphate particles with at least a portion of a surface provided with a carbon material. In a cumulative distribution curve of a graphitization degree C value obtained from the positive electrode film layer in an area mapping mode of a laser microscopic confocal Raman spectrometer, a median C₅₀ of the graphitization degree ranges from 0.95 to 1.20. The graphitization degree C value is I_{G}/I_{D}. I_{G} represents the intensity of the G band at 1580±100 cm⁻¹ in Raman spectra, and I_{D} represents the intensity of the D band at 1350±100 cm⁻¹ in Raman spectra. When the battery cell is in a fully-discharged state, a compaction density of the positive electrode plate ranges from 2.3 g/cm³ to 2.6 g/cm³. When the battery cell has a good capacity, a cycle life of the battery in a long cycle process is improved.

As can be seen from comparison between Example 1, Examples 4 to 6, and Example 7, in the cumulative distribution curve of the graphitization degree C value obtained from the positive electrode film layer in the area mapping mode of the laser microscopic confocal Raman spectrometer, the median C₅₀ of the graphitization degree ranges from 1.01 to 1.13, to help further improve the cycle life of the battery cell in the long cycle process.

As can be seen from comparison between Examples 1 to 10 and Comparative example 1, in the cumulative distribution curve of the graphitization degree C value obtained from the positive electrode film layer in the area mapping mode of the laser microscopic confocal Raman spectrometer, the concentration degree (C₉₀-C₁₀)/C₅₀ of the C value ranges from 0.01 to 0.05, to help further improve the cycle life of the battery cell in the long cycle process.

As can be seen from Examples 1 to 3, in the cross section of the positive electrode film layer in the thickness direction of the positive electrode plate, in the area-weighted cumulative distribution curve of the sphericity of the particles whose particle size R1 meets R1≥1000 nm, L_{R1450} ranges from 0.67 to 0.75, so that the battery cell has a good cycle life in the long cycle process.

As can be seen from Examples 1 to 9, the single-side thickness H of the positive electrode film layer ranges from 70 μm to 120 μm, so that when the battery cell has a good capacity, the cycle life of the battery in the long cycle process is improved.

It should be noted that the present application is not limited to the above embodiments. The foregoing implementations are exemplary only, and any implementation within the scope of the technical solution of the present application that has substantially the same composition and has the same effects as the technical idea is encompassed in the technical scope of the present application. In addition, other embodiments constructed by applying various modifications conceivable to those skilled in the art to the embodiments and combining some of the constituent elements of the embodiments without departing from the scope of the essence of the present application are also included in the scope of the present application.

1. A battery cell, comprising a stacked electrode assembly, wherein the stacked electrode assembly comprises a positive electrode plate and a negative electrode plate, the positive electrode plate comprises a positive electrode current collector and a positive electrode film layer disposed on at least one side of the positive electrode current collector, the positive electrode film layer comprises lithium-containing transition metal phosphate particles with at least a portion of a surface provided with a carbon material,
in a cumulative distribution curve of a graphitization degree C value obtained from the positive electrode film layer in an area mapping mode of a laser microscopic confocal Raman spectrometer, a median C₅₀ of the graphitization degree ranges from 0.95 to 1.20, wherein
the graphitization degree C value is I_{G}/I_{D}, I_{G} represents an intensity of a G band at 1580±100 cm⁻¹ in Raman spectra, and I_{P} represents an intensity of a D band at 1350±100 cm⁻¹ in Raman spectra,
when the battery cell is in a fully-discharged state, a compaction density of the positive electrode plate ranges from 2.3 g/cm³ to 2.6 g/cm³, and
in a cross section of the positive electrode film layer in a thickness direction of the electrode plate, in an area-weighted cumulative distribution curve of sphericity of particles whose particle size R1 meets R1≥1000 nm, a median L_{R1A50} of sphericity ranges from 0.6 to 0.8, wherein the sphericity is a Round parameter obtained by using a shape description analysis function in ImageJ to analyze morphology of the particles in the cross section, and the Round parameter represents a ratio of a pixel area of one of the particles to an area of a circle with a fitted major axis of the particle as a diameter.

2. The battery cell according to claim 1, wherein in the cumulative distribution curve of the graphitization degree C value obtained from the positive electrode film layer in the area mapping mode of the laser microscopic confocal Raman spectrometer, the median C₅₀ of the graphitization degree ranges from 1.01 to 1.13.

3. The battery cell according to claim 1, wherein in the cumulative distribution curve of the graphitization degree C value obtained from the positive electrode film layer in the area mapping mode of the laser microscopic confocal Raman spectrometer, a concentration degree (C₉₀-C₁₀)/C₅₀ of the C value ranges from 0.01 to 0.05.

4. The battery cell according to claim 1, wherein based on a total area of particles in a cross section of the positive electrode film layer in a thickness direction of the electrode plate, an area percentage of particles whose particle size R1 meets R1≥1000 nm ranges from 12% to 50%.

5. The battery cell according to claim 1, wherein in a cross section of the positive electrode film layer in a thickness direction of the electrode plate, in an area-weighted cumulative distribution curve of sphericity of particles whose particle size R1 meets R1≥1000 nm, a median L_{R1A50} of sphericity ranges from 0.67 to 0.75.

6. The battery cell according to claim 1, wherein in a cumulative distribution curve of a coating value B obtained from the positive electrode film layer in the area mapping mode of the laser microscopic confocal Raman spectrometer, a median B₅₀ of the coating value B ranges from 0.30 to 0.60, wherein
the coating value B is I_{P}/I_{D}, I_{P} represents an intensity of a P band at 948+100 cm⁻¹ in Raman spectra, and I_{D} represents an intensity of a D band at 1350+100 cm⁻¹ in Raman spectra.

7. The battery cell according to claim 1, wherein the lithium-containing transition metal phosphate particles comprise a component shown in the following general formula:
LiₘFeₓP_{y}OⱼQ_{q} Formula I, wherein
Q comprises one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

8. The battery cell according to claim 1, wherein
an iron dissolution rate of a positive electrode active material ranges from 658 ppm to 1921 ppm;
based on a total mass of the lithium-containing transition metal phosphate particles, a mass content of titanium ranges from 500 ppm to 8000 ppm;
based on a total mass of the lithium-containing transition metal phosphate particles in the positive electrode film layer, a mass content of vanadium ranges from 500 ppm to 5000 ppm; and/or
a resistivity of the positive electrode film layer ranges from 10 Ω·cm to 35 Ω·cm.

9. The battery cell according to claim 1, wherein a porosity of the positive electrode film layer ranges from 14% to 28%.

10. The battery cell according to claim 1, wherein a single-side thickness of the positive electrode film layer is denoted as H, H ranges from 70 μm to 120 μm.

11. The battery cell according to claim 1, wherein a base coating layer is disposed in a bottom region of the positive electrode film layer close to the positive electrode current collector, and the base coating layer meets at least one of the following conditions:
(1) the base coating layer comprises a conductive agent and a binder, the conductive agent comprises carbon nanotubes and conductive carbon black, and the binder comprises a vinylidene fluoride polymer; and
(2) a thickness of the base coating layer ranges from 0.5 μm to 5 μm.

12. The battery cell according to claim 1, wherein the positive electrode film layer further comprises a dispersant, and the dispersant comprises hydrogenated nitrile butadiene rubber (HNBR).

13. The battery cell according to claim 1, wherein
based on a mass of the positive electrode film layer, a mass content of a dispersant ranges from 0.5% to 2%; and/or
the positive electrode film layer further comprises a conductive agent, and based on a total area of a cross section of the positive electrode film layer in a thickness direction of the electrode plate, an area percentage of agglomeration regions of the conductive agent ranges from 0.5% to 2.5%, wherein the conductive agent comprises carbon nanotubes, the carbon nanotubes comprise one or more of single-walled carbon nanotubes, few-walled carbon nanotubes, and multi-walled carbon nanotubes;
the agglomeration regions of the conductive agent comprise carbon nanotubes and conductive carbon black, wherein based on a mass of the positive electrode film layer, a mass content C1 of the carbon nanotubes meets: 0<C1≤2.5%, and a mass content C2 of the conductive carbon black meets: 0<C2≤2.5%.

14. The battery cell according to claim 1, wherein the battery cell further comprises a separator disposed between the positive electrode plate and the negative electrode plate, the separator comprises a base film, a ceramic layer disposed on each of two sides of the base film, and a bonding layer disposed on a side of the ceramic layer on at least one side away from the base film, the bonding layer is a continuous layer with a porous structure, and the bonding layer comprises a vinylidene fluoride-based polymer, wherein the separator meets at least one of the following conditions:
(1) a thickness of the base film ranges from 7 μm to 9 μm;
(2) a single-side thickness of the ceramic layer ranges from 2 μm to 4 μm; and
(3) a single-side thickness of the bonding layer ranges from 1 μm to 5 μm.

15. The battery cell according to claim 1, wherein the battery cell comprises a housing, at least one stacked electrode assembly is accommodated in the housing, a dimension of the housing in a length direction is L0, a dimension of the housing in a width direction is W₀, a dimension of the housing in a thickness direction is H0, 450 mm≤L0≤1300 mm, 100 mm≤W₀≤150 mm, and 14 mm≤H0≤22 mm.

16. The battery cell according to claim 15, wherein
(1) the housing is made of a pouch-type material, and the pouch-type material comprises an aluminum laminate composite film;
(2) the housing comprises a first sealing zone, and the first sealing zone is disposed at at least one end of the stacked electrode assembly extending along the width direction; the first sealing zone comprises a folded edge structure extending along the length direction, a sealing adhesive is disposed on the folded edge structure, and the sealing adhesive is continuously disposed in the length direction and secures the folded edge structure; and
(3) the housing comprises at least one second sealing zone, the second sealing zone is disposed at at least one end of the stacked electrode assembly in the length direction of the housing, and the second sealing zone is disposed on a tab side of the stacked electrode assembly.

17. The battery cell according to claim 1, wherein an outer periphery of the stacked electrode assembly is provided with a plurality of adhesive rings surrounding along the width direction, and the adhesive rings surrounding along the width direction are disposed at intervals along the length direction.

18. The battery cell according to claim 1, wherein at 25 °C, a capacity of the battery cell ranges from 105 Ah to 190 Ah.

19. A battery apparatus, comprising the battery cell according to claim 1.

20. An energy storage apparatus, wherein the energy storage apparatus comprises the battery apparatus according to claim 18, and the battery apparatus is configured to store electric energy.
